(19) United States
(12) Patent Application Publication
(10) Pub. No.: US 2023/0361308 A1
(43) Pub. Date: Nov. 9, 2023

(54) DISPERSIONS OF CARBON NANOTUBES FOR USE IN COMPOSITIONS FOR MANUFACTURING BATTERY ELECTRODES

(71) Applicant: PPG Industries Ohio, Inc., Cleveland, OH (US)

(72) Inventors: Stuart D. Hellring, Pittsburgh, PA (US); Peter L. Votruba-Drzal, Pittsburgh, PA (US); Zhilian Zhou, Sewickley, PA (US); Kevin T. Sylvester, Pittsburgh, PA (US); Scott W. Sisco, Glenshaw, PA (US)

(73) Assignee: PPG Industries Ohio, Inc., Cleveland, OH (US)

(21) Appl. No.: 18/041,890

(22) PCT Filed: Aug. 19, 2021
(86) PCT No.: PCT/US2021/046688

§ 371 Date: Feb. 16, 2023

Related U.S. Application Data
(60) Provisional application No. 63/067,585, filed on Aug. 19, 2020.

(51) Int. Cl. H01M 4/62

(52) U.S. Cl. CPC H01M 4/625; H01M 4/623

(57) ABSTRACT

The present invention provides a dispersion of carbon nanotubes comprising an organic medium, carbon nanotubes dispersed in the organic medium, and a dispersant. The present invention further provides slurry compositions that include such dispersion, electrodes produced from the slurry composition, and electrical storage devices that comprise the electrode.

### CROSS-REFERENCE TO RELATED APPLICATIONS

This application claims the benefit of U.S. Provisional Pat. Application Serial No. 63/067,585, filed on Aug. 19, 2020, incorporated herein by reference.

### FIELD OF THE INVENTION

The invention relates to carbon nanotube dispersions that could be used in compositions for manufacturing electrodes for use in electrical storage devices, such as batteries.

### BACKGROUND OF THE INVENTION

There is a trend in the electronics industry to produce smaller devices, powered by smaller and lighter batteries. Batteries with a negative electrode--such as a carbonaceous material and silicon (oxide), and a positive electrode--such as lithium metal oxides can provide relatively high power and low weight. Such electrodes are typically produced from a solvent slurry that includes an organic solvent, binder, the active material (e.g., carbonaceous material or lithium metal oxides), and an optional electrically conductive agent.

Currently, the binder of choice is polyvinylidene difluoride (PVDF), and the organic solvent of choice is N-methyl-2-pyrrolidone (NMP). PVDF binders dissolved in NMP provide superior adhesion and an interconnectivity of all the active ingredients in the electrode composition. Unfortunately, NMP is a toxic material and presents health and environmental issues, and it would be desirable to replace NMP as a solvent for PVDF binders. However, NMP is somewhat unique in its ability to dissolve PVDF, which is not soluble in many other organic solvents.

The electrically conductive agent typically has been carbon black or graphite. Carbon nanotubes are of interest because of their good electrical conductivity and high-aspect ratio form a three-dimensional conductive network when added into the positive and negative electrode materials of a lithium ion battery, and this can lead to improved performance properties for the battery such as improved capacity and cycle life. However, the nano-size of carbon nanotubes necessitates restrictions in handling dry carbon nanotubes, and carbon nanotubes have proven to be difficult to adequately disperse which results in decreased battery performance. In addition, dispersants used for NMP-based slurries may lack compatibility with alternative solvent systems used in battery electrode slurries.

It is therefore an object of the present invention to provide carbon nanotube dispersions using alternatives to N-methyl-2-pyrrolidone for use in preparing electrode-forming compositions and for producing high quality electrodes for batteries and other electrical storage devices.

### SUMMARY OF THE INVENTION

The present invention provides a dispersion of carbon nanotubes comprising an organic medium, carbon nanotubes dispersed in the organic medium, and a dispersant.

The present invention also provides a slurry composition for producing a battery electrode comprising the dispersion of the present invention, an electrochemically active material, and a binder.

The present invention further provides an electrode comprising an electrical current collector and a film formed on the electrical current collector, wherein the film is deposited from the slurry composition of the present invention.

The present invention further provides an electrical storage device comprising the electrode of the present invention, a counter electrode and an electrolyte.

### BRIEF DESCRIPTION OF THE DRAWINGS

FIG. 1A, FIG. 1B, FIG. 1C, and FIG. 1D are micrograph images of carbon nanotubes dispersed in an organic medium with different dispersants.

FIG. 2A and FIG. 2B are photographs of comparative and inventive carbon nanotube dispersion compositions that show the behavior of a portion of the composition when it is applied to a steel substrate.

FIG. 3 is a graph showing viscosity relative to shear rate for comparative and inventive carbon nanotube dispersions.

### DETAILED DESCRIPTION

The present invention is directed to a dispersion of carbon nanotubes comprising an organic medium, carbon nanotubes dispersed in the organic medium, and a dispersant.

As used herein, the term “carbon nanotube” refers to a carbon allotrope comprising one or more cylindrical layers of carbon atoms covalently bonded into a hexagonal tiling pattern (i.e., a sheet of graphene) that form a hollow tube structure having a diameter of up to a few hundred nanometers. The term “graphene” refers to a one-atom-thick planar sheet of sp²-bonded carbon atoms that are densely packed in a honeycomb crystal lattice. A “single-wall carbon nanotube” refers to a single cylindrical layer of carbon atoms. A “multi-wall carbon nanotube” refers to two or more layers of carbon atoms joined by intermolecular forces or a single layer of carbon atoms rolled up several times around a cylindrical hollow core. For example, as shown below (from T. Belin et al., Characterization Methods of Carbon Nanotubes: A Review, 119 MATERIALS SCIENCE AND ENGINEERING B 105-18 (2005)), the multi-wall carbon nanotube may have a cylindrical cross-sectional shape as in (a), a polygonal cross-sectional shape as in (b), or be a single layer of carbon atoms rolled up around a cylindrical or polygonal hollow core as in (c), with (a) and (b) sometimes referred to as the Russian Doll model and (c) referred to as the Parchment model.

[image]

Carbon nanotubes are also classified based upon the rolling axis relative to the hexagonal lattice of the sheet of graphene. For example, as shown below (N. Saifuddin et al., Carbon Nanotubes: A Review on Structure and Their Interaction With Proteins, 2013 JOURNAL OF CHEMISTRY, Article ID 676815 (2013)), the lattice may have an armchair, zigzag, or chiral configuration. The configuration may be expressed using (n,m) notation which determines the chirality and other properties of carbon nanotube (including optical, mechanical, and electronic properties). The values of n and m may be determined by slicing open the tube by a cut parallel to its axis that goes through an atom A, unrolling the strip flat on a plane so that its atoms and bonds coincide with those of an imaginary graphene sheet with the two halves of the atom A (A1 and A2) on opposite edges of the strip, drawing two independent linear vectors a1 and a2 from atom A1, and measuring the number of atoms along each vector to get to the position of A2 with the vector from A1 to A2 written as a linear combination n u + m v, wherein n and m are integers, and the linear combination can be noted as (n,m).

[image]

Carbon nanotubes may be substituted with functional groups or other defects depending on their method of production and purification particularly at the ends of the tube. For example, carbon nanotubes may comprise oxygen, sulfur, nitrogen, fluorine, or other substituent atoms, and may comprise, for example, carbonyl, hydroxyl, thiol, amine, and/or amide functional groups. Amorphous carbon and residual catalysts, such as iron or nickel, may also be present in addition to other impurities. Exemplary carbon nanotube synthesis processes include arc discharge, laser ablation, chemical vapor deposition (CVD) and high-pressure carbon monoxide disproportionation (HiPCO). Some common post-synthesis treatments or modifications for carbon nanotubes include ozone treatment, ozone and hydrogen peroxide treatments, hydrochloric acid treatment, sodium/potassium hydroxide treatment and/or heat treatment.

Carbon nanotubes may be characterized by various techniques used in the art. For example, X-ray photoelectron spectroscopy (XPS) may be used measure nitrogen, oxygen, sulfur, or fluorine/halogen content and may indicate the level of impurities and functionalization. Raman spectroscopy can be used to indicate the level of purity, i.e., how pristine the graphene sheets are, that make up the carbon nanotube. BET measurements can be used to measure the surface area of the carbon nanotube, the measurement is impacted by the nature of the carbon nanotube structure (e.g., single versus multi-wall nanotubes) and functionalization and defects of the nanotube structure that may modify the measured value relative the theoretical value. Lastly, electron microscopy may also be used to analyze the surface of the carbon nanotube as well as the particle shape and size.

The carbon nanotubes may have a heteroatom (e.g., oxygen, sulfur, nitrogen, fluorine or other halogens) content of no more than 10 atomic weight percent, such as no more than 5 atomic weight percent, such as no more than 2 atomic weight percent, such as no more than 1.5 atomic weight percent, such as no more than 1 atomic weight percent, such as no more than 0.6 atomic weight, such as no more than 0.5 atomic weight percent. The heteroatom content of the carbon nanotubes can be determined using XPS, such as is described in D. R. Dreyer et al., Chem. Soc. Rev. 39, 228-240 (2010).

The carbon nanotubes may have a heteroatom content in the amount of 1 heteroatom out of 1000 total atoms (carbon and heteroatom(s)), such as 1 out of 500, such as 1 out of 250, such as 1 out of 200, such as 1 out of 150, such as 1 out of 100, such as 1 out of 75, such as 1 out of 60, such as 1 out of 50, such as 1 out of 40, such as 1 out of 35, such as 1 out of 30, such as 1 out of 25, such as 1 out of 17.5, such as 1 out of 15, such as 1 out of 12.5, such as 1 out of 10.

The carbon nanotubes may have a heteroatom concentration as a molar percentage of total atoms of the carbon nanotube (carbon and heteroatom(s)) of at least 0.1%, such as at least such as at least 0.2%, such as at least 0.4%, such as at least 0.5%, such as at least 0.67%, such as at least 1%, such as at least 1.3%, such as at least 1.67%, such as at least 2%, such as at least 2.5%, such as at least 2.85%, such as at least 3.3%, such as at least 4%, such as at least 5.7%, such as at least 6.67%, such as at least 8%, such as at least 10%. The carbon nanotubes may have a heteroatom concentration as a molar percentage of total atoms of the carbon nanotube (carbon and heteroatom(s)) of no more than 10%, such as no more than 8%, such as no more than 6.67%, such as no more than 5.7%, such as no more than 4%, such as no more than 3.3%, such as no more than 2.85%, such as no more than 2.5%, such as no more than 2%, such as no more than 1.67%, such as no more than 1.3%, such as no more than 1%, such as no more than 0.67%, such as no more than 0.5%, such as no more than 0.4%, such as no more than 0.2%, such as no more than 0.1%. The carbon nanotubes may have a heteroatom concentration as a molar percentage of total atoms of the carbon nanotube (carbon and heteroatom(s)) of 0.1% to 10%, such as 0.1% to 8%, such as 0.1% to 6.67%, such as 0.1% to 5.7%, such as 0.1% to 4%, such as 0.1% to 3.3%, such as 0.1% to 2.85%, such as 0.1% to 2.5%, such as 0.1% to 2%, such as 0.1% to 1.67%, such as 0.1% to 1.3%, such as 0.1% to 1%, such as 0.1% to 0.67%, such as 0.1% to 0.5%, such as 0.1% to 0.4%, such as 0.1% to 0.2%, such as 0.2% to 10%, such as 0.2% to 8%, such as 0.2% to 6.67%, such as 0.2% to 5.7%, such as 0.2% to 4%, such as 0.2% to 3.3%, such as 0.2% to 2.85%, such as 0.2% to 2.5%, such as 0.2% to 2%, such as 0.2% to 1.67%, such as 0.2% to 1.3%, such as 0.2% to 1%, such as 0.2% to 0.67%, such as 0.2% to 0.5%, such as 0.2% to 0.4%, such as 0.4% to 10%, such as 0.4% to 8%, such as 0.4% to 6.67%, such as 0.4% to 5.7%, such as 0.4% to 4%, such as 0.4% to 3.3%, such as 0.4% to 2.85%, such as 0.4% to 2.5%, such as 0.4% to 2%, such as 0.4% to 1.67%, such as 0.4% to 1.3%, such as 0.4% to 1%, such as 0.4% to 0.67%, such as 0.4% to 0.5%, such as 0.5% to 10%, such as 0.5% to 8%, such as 0.5% to 6.67%, such as 0.5% to 5.7%, such as 0.5% to 4%, such as 0.5% to 3.3%, such as 0.5% to 2.85%, such as 0.5% to 2.5%, such as 0.5% to 2%, such as 0.5% to 1.67%, such as 0.5% to 1.3%, such as 0.5% to 1%, such as 0.5% to 0.67%, such as 0.67% to 10%, such as 0.67% to 8%, such as 0.67% to 6.67%, such as 0.67% to 5.7%, such as 0.67% to 4%, such as 0.67% to 3.3%, such as 0.67% to 2.85%, such as 0.67% to 2.5%, such as 0.67% to 2%, such as 0.67% to 1.67%, such as 0.67% to 1.3%, such as 0.67% to 1%, such as 1% to 10%, such as 1% to 8%, such as 1% to 6.67%, such as 1% to 5.7%, such as 1% to 4%, such as 1% to 3.3%, such as 1% to 2.85%, such as 1% to 2.5%, such as 1% to 2%, such as 1% to 1.67%, such as 1% to 1.3%, such as 1.3% to 10%, such as 1.3% to 8%, such as 1.3% to 6.67%, such as 1.3% to 5.7%, such as 1.3% to 4%, such as 1.3% to 3.3%, such as 1.3% to 2.85%, such as 1.3% to 2.5%, such as 1.3% to 2%, such as 1.3% to 1.67%, such as 1.67% to 10%, such as 1.67% to 8%, such as 1.67% to 6.67%, such as 1.67% to 5.7%, such as 1.67% to 4%, such as 1.67% to 3.3%, such as 1.67% to 2.85%, such as 1.67% to 2.5%, such as 1.67% to 2%, such as 2% to 10%, such as 2% to 8%, such as 2% to 6.67%, such as 2% to 5.7%, such as 2% to 4%, such as 2% to 3.3%, such as 2% to 2.85%, such as 2% to 2.5%, such as 2.5% to 10%, such as 2.5% to 8%, such as 2.5% to 6.67%, such as 2.5% to 5.7%, such as 2.5% to 4%, such as 2.5% to 3.3%, such as 2.5% to 2.85%, such as 2.85% to 10%, such as 2.85% to 8%, such as 2.85% to 6.67%, such as 2.85% to 5.7%, such as 2.85% to 4%, such as 2.85% to 3.3%, such as 3.3% to 10%, such as 3.3% to 8%, such as 3.3% to 6.67%, such as 3.3% to 5.7%, such as 3.3% to 4%, such as 4% to 10%, such as 4% to 8%, such as 4% to 6.67%, such as 4% to 5.7%, such as 5.7% to 10%, such as 5.7% to 8%, such as 5.7% to 6.67%, such as 6.67% to 10%, such as 6.67% to 8%, such as 8% to 10%.

The theoretical maximum surface area for closed single-walled CNT is of 1315 m²/g; however, deviations can occur during the synthesis or post-synthesis modification steps. The carbon nanotubes may have a BET surface area of at least 10 m²/g, such as at least 20 m²/g, such as at least 50 m²/g, such as at least 100 m²/g, such as at least 200 m²/g, such as at least 250 m²/g, such as at least 300 m²/g, such as at least 400 m²/g, such as at least 500 m²/g, such as at least 550 m²/g, such as at least 600 m²/g, such as at least 800 m²/g, such as at least 1,000 m²/g. The carbon nanotubes may have a BET surface area of no more than 2,000 m²/g, such as no more than 1,750 m²/g, such as no more than 1,600 m²/g, such as no more than 1,500 m²/g, such as no more than 1,400 m²/g, such as no more than 1,300 m²/g, such as no more than 1,200 m²/g, such as no more than 1,100 m²/g, such as no more than 1,000 m²/g, such as no more than 900 m²/g, such as no more than 800 m²/g, such as no more than 700 m²/g, such as no more than 600 m²/g, such as no more than 500 m²/g, such as no more than 400 m²/g, such as no more than 300 m²/g, such as no more than 200 m²/g, such as no more than 100 m²/g, such as no more than 50 m²/g. The carbon nanotubes may have a BET surface area of 10 to 2,000 m²/g, such as 10 to 1,750 m²/g, such as 10 to 1,600 m²/g, such as 10 to 1,500 m²/g, such as 10 to 1,400 m²/g, such as 10 to 1,300 m²/g, such as 10 to 1,200 m²/g, such as 10 to 1,100 m²/g, such as 10 to 1,000 m²/g, such as 10 to 900 m²/g, such as 10 to 800 m²/g, such as 10 to 700 m²/g, such as 10 to 600 m²/g, such as 10 to 500 m²/g, such as 10 to 400 m²/g, such as 10 to 300 m²/g, such as 10 to 200 m²/g, such as 10 to 100 m²/g, such as 10 to 50 m²/g, such as 20 to 2,000 m²/g, such as 20 to 1,750 m²/g, such as 20 to 1,600 m²/g, such as 20 to 1,500 m²/g, such as 20 to 1,400 m²/g, such as 20 to 1,300 m²/g, such as 20 to 1,200 m²/g, such as 20 to 1,100 m²/g, such as 20 to 1,000 m²/g, such as 20 to 900 m²/g, such as 20 to 800 m²/g, such as 20 to 700 m²/g, such as 20 to 600 m²/g, such as 20 to 500 m²/g, such as 20 to 400 m²/g, such as 20 to 300 m²/g, such as 20 to 200 m²/g, such as 20 to 100 m²/g, such as 20 to 50 m²/g, such as 50 to 2,000 m²/g, such as 50 to 1,750 m²/g, such as 50 to 1,600 m²/g, such as 50 to 1,500 m²/g, such as 50 to 1,400 m²/g, such as 50 to 1,300 m²/g, such as 50 to 1,200 m²/g, such as 50 to 1,100 m²/g, such as 50 to 1,000 m²/g, such as 50 to 900 m²/g, such as 50 to 800 m²/g, such as 50 to 700 m²/g, such as 50 to 600 m²/g, such as 50 to 500 m²/g, such as 50 to 400 m²/g, such as 50 to 300 m²/g, such as 50 to 200 m²/g, such as 50 to 100 m²/g, such as 100 to 2,000 m²/g, such as 100 to 1,750 m²/g, such as 100 to 1,600 m²/g, such as 100 to 1,500 m²/g, such as 100 to 1,400 m²/g, such as 100 to 1,300 m²/g, such as 100 to 1,200 m²/g, such as 100 to 1,100 m²/g, such as 100 to 1,000 m²/g, such as 100 to 900 m²/g, such as 100 to 800 m²/g, such as 100 to 700 m²/g, such as 100 to 600 m²/g, such as 100 to 500 m²/g, such as 100 to 400 m²/g, such as 100 to 300 m²/g, such as 100 to 200 m²/g, such as 200 to 2,000 m²/g, such as 200 to 1,7200 m²/g, such as 200 to 1,600 m²/g, such as 200 to 1,500 m²/g, such as 200 to 1,400 m²/g, such as 200 to 1,300 m²/g, such as 200 to 1,200 m²/g, such as 200 to 1,100 m²/g, such as 200 to 1,000 m²/g, such as 200 to 900 m²/g, such as 200 to 800 m²/g, such as 200 to 700 m²/g, such as 200 to 600 m²/g, such as 200 to 500 m²/g, such as 200 to 400 m²/g, such as 200 to 300 m²/g, such as 300 to 2,000 m²/g, such as 300 to 1,7300 m²/g, such as 300 to 1,600 m²/g, such as 300 to 1,500 m²/g, such as 300 to 1,400 m²/g, such as 300 to 1,300 m²/g, such as 300 to 1,200 m²/g, such as 300 to 1,100 m²/g, such as 300 to 1,000 m²/g, such as 300 to 900 m²/g, such as 300 to 800 m²/g, such as 300 to 700 m²/g, such as 300 to 600 m²/g, such as 300 to 500 m²/g, such as 300 to 400 m²/g, such as 400 to 2,000 m²/g, such as 400 to 1,7400 m²/g, such as 400 to 1,600 m²/g, such as 400 to 1,500 m²/g, such as 400 to 1,400 m²/g, such as 400 to 1,300 m²/g, such as 400 to 1,200 m²/g, such as 400 to 1,100 m²/g, such as 400 to 1,000 m²/g, such as 400 to 900 m²/g, such as 400 to 800 m²/g, such as 400 to 700 m²/g, such as 400 to 600 m²/g, such as 400 to 500 m²/g, such as 500 to 2,000 m²/g, such as 500 to 1,750 m²/g, such as 500 to 1,600 m²/g, such as 500 to 1,500 m²/g, such as 500 to 1,400 m²/g, such as 500 to 1,300 m²/g, such as 500 to 1,200 m²/g, such as 500 to 1,100 m²/g, such as 500 to 1,000 m²/g, such as 500 to 900 m²/g, such as 500 to 800 m²/g, such as 500 to 700 m²/g, such as 500 to 600 m²/g, such as 600 to 2,000 m²/g, such as 600 to 1,750 m²/g, such as 600 to 1,600 m²/g, such as 600 to 1,500 m²/g, such as 600 to 1,400 m²/g, such as 600 to 1,300 m²/g, such as 600 to 1,200 m²/g, such as 600 to 1,100 m²/g, such as 600 to 1,000 m²/g, such as 600 to 900 m²/g, such as 600 to 800 m²/g, such as 600 to 700 m²/g, such as 700 to 2,000 m²/g, such as 700 to 1,750 m²/g, such as 700 to 1,600 m²/g, such as 700 to 1,500 m²/g, such as 700 to 1,400 m²/g, such as 700 to 1,300 m²/g, such as 700 to 1,200 m²/g, such as 700 to 1,100 m²/g, such as 700 to 1,000 m²/g, such as 700 to 900 m²/g, such as 700 to 800 m²/g, such as 800 to 2,000 m²/g, such as 800 to 1,750 m²/g, such as 800 to 1,600 m²/g, such as 800 to 1,500 m²/g, such as 800 to 1,400 m²/g, such as 800 to 1,300 m²/g, such as 800 to 1,200 m²/g, such as 800 to 1,100 m²/g, such as 800 to 1,000 m²/g, such as 800 to 900 m²/g, such as 900 to 2,000 m²/g, such as 900 to 1,750 m²/g, such as 900 to 1,600 m²/g, such as 900 to 1,500 m²/g, such as 900 to 1,400 m²/g, such as 900 to 1,300 m²/g, such as 900 to 1,200 m²/g, such as 900 to 1,100 m²/g, such as 900 to 1,000 m²/g, such as 1,000 to 2,000 m²/g, such as 1,000 to 1,750 m²/g, such as 1,000 to 1,600 m²/g, such as 1,000 to 1,500 m²/g, such as 1,000 to 1,400 m²/g, such as 1,000 to 1,300 m²/g, such as 1,000 to 1,200 m²/g, such as 1,000 to 1,100 m²/g. As used herein, the term “BET surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

Raman spectroscopy is a useful technique for determining the nature of carbonaceous materials (e.g.: graphite, graphene, carbon black, CNT, etc.). All sp² carbon systems have a peak in the Raman spectrum ranging between 1500 cm⁻¹ and 1600 cm⁻¹ called the G-band (from “graphite”), resulting from the C-C bond stretching. This peak is sensitive to strain effects; the peak shape and multiplicity can be used to distinguish between nanocarbon species (e.g.: graphene and carbon nanotubes). Another notable feature in the Raman spectrum of graphenic carbon systems, a peak falling in between 2500 and 2800 cm⁻¹, is called the dispersive G′-band (or 2D-band). The peak shape and multiplicity the 2D-band are unique for the nature of the nanocarbon species (e.g., graphene and carbon nanotubes). The 2D-peak can help assign the number of layers in a sheet of graphene as well as distinguish between SWCNT and MWCNT. The ratio of the peak intensities of these two peaks facilitates discrimination between nanosized sp²-carbon species. As used herein, the term “2D/G peak ratio” refers to the ratio of the intensity of the 2D peak between 2500 and 2800 cm⁻¹ in a Raman spectrum to the intensity of the G peak between 1,500 and 1600 cm⁻¹ in the Raman spectrum. For a perfect single sheet of crystalline graphene, the 2D/G peak ratio is 2:1 and the numerator will decrease in magnitude as the number of layers in graphene increase. Carbon nanotubes may have a Raman spectroscopy 2D/G peak ratio of at least at least 0.15:1.0, such as at least 0.20:1.0, such as at least 0.25:1.0, such as at least 0.30:1.0, such as at least 0.40:1.0, such as at least 0.50:1.0, such as at least 0.55:1.0, such as at least 0.60:1.0. Carbon nanotubes may have a Raman spectroscopy 2D/G peak ratio of no more than 1.50:1, such as no more than 1.25:1.0, such as no more than 1.0:1.0, such as no more than 0.90:1.0, such as no more than 0.80:1.0, such as no more than 0.75:1.0, such as no more than 0.65:1.0, such as no more than 0.60:1.0, such as no more than 0.55:1.0. Carbon nanotubes may have a Raman spectroscopy 2D/G peak ratio of 0.15:1.0 to 1.50:1.0, such as 0.15:1.0 to 1.25:1.0, such as 0.15:1.0 to 1.0:1.0, such as 0.20:1.0 to 1.0:1.0, such as 0.30:1.0 to 1.0:1.0, such as 0.40:1.0 to 1.0:1.0, such as 0.50:1.0 to 1.0:1.0, such as 0.60:1.0 to 1.0:1.0, such as 0.20:1.0 to 0.80:1.0, such as 0.30:1.0 to 0.80:1.0, such as 0.40:1.0 to 0.80:1.0, such as 0.50:1.0 to 0.80:1.0, such as 0.20:1.0 to 0.90:1.0, such as 0.25:1.0 to 0.80:1.0, such as 0.30:1.0 to 0.75:1.0, such as 0.30:1.0 to 0.65:1.0, such as 0.30:1.0 to 0.60:1.0, such as 0.30:1.0 to 0.55:1.0, such as 0.30:1.0 to 0.50:1.0, such as 0.40:1.0 to 0.75:1.0, such as 0.40:1.0 to 0.65:1.0, such as 0.40:1.0 to 0.60:1.0, such as 0.40:1.0 to 0.55:1.0, such as 0.40:1.0 to 0.50:1.0.

The carbon nanotubes may have a length of at least 25 nm, such as at least 50 nm, such as at least 75 nm, such as at least 100 nm, such as at least 300 nm, such as at least 500 nm, such as at least 1 micron, such as at least 5 microns, such as at least 10 microns, such as at least 20 microns, such as at least 50 microns, such as at least 100 microns, such as at least 200 microns, or longer. The carbon nanotubes may have a length of no more than 25 mm, such as no more than 15 mm, such as no more than 10 mm, such as no more than 5 mm, such as no more than 1 mm, such as no more than 500 microns, such as no more than 250 microns, such as no more than 200 microns, such as no more than 100 microns, such as no more than 50 microns, such as no more than 30 microns, such as no more than 20 microns, such as no more than 10 microns, such as no more than 5 microns, such as no more than 3 microns, such as no more than 1 micron, such as no more than 500 nm. The carbon nanotubes may have a length of 25 nm to 25 mm, such as 25 nm to 15 mm, such as 25 nm to 10 mm, such as 25 nm to 5 mm, such as 25 nm to 1 mm, such as 25 nm to 500 microns, such as 25 nm to 250 microns, such as 25 nm to 200 microns, such as 25 nm to 25 microns, such as 25 nm to 50 microns, such as 25 nm to 30 microns, such as 25 nm to 20 microns, such as 25 nm to 10 microns, such as 25 nm to 5 microns, such as 25 nm to 3 microns, such as 25 nm to 1 micron, such as 25 nm to 500 nm, such as 50 nm to 25 mm, such as 50 nm to 15 mm, such as 50 nm to 10 mm, such as 50 nm to 5 mm, such as 50 nm to 1 mm, such as 50 nm to 500 microns, such as 50 nm to 250 microns, such as 50 nm to 200 microns, such as 50 nm to 50 microns, such as 50 nm to 50 microns, such as 50 nm to 30 microns, such as 50 nm to 20 microns, such as 50 nm to 10 microns, such as 50 nm to 5 microns, such as 50 nm to 3 microns, such as 50 nm to 1 micron, such as 50 nm to 500 nm, such as 75 nm to 25 mm, such as 75 nm to 15 mm, such as 75 nm to 10 mm, such as 75 nm to 5 mm, such as 75 nm to 1 mm, such as 75 nm to 500 microns, such as 75 nm to 250 microns, such as 75 nm to 200 microns, such as 75 nm to 75 microns, such as 75 nm to 50 microns, such as 75 nm to 30 microns, such as 75 nm to 20 microns, such as 75 nm to 10 microns, such as 75 nm to 5 microns, such as 75 nm to 3 microns, such as 75 nm to 1 micron, such as 75 nm to 500 nm, such as 100 nm to 25 mm, such as 100 nm to 15 mm, such as 100 nm to 10 mm, such as 100 nm to 5 mm, such as 100 nm to 1 mm, such as 100 nm to 500 microns, such as 100 nm to 250 microns, such as 100 nm to 200 microns, such as 100 nm to 100 microns, such as 100 nm to 50 microns, such as 100 nm to 30 microns, such as 100 nm to 20 microns, such as 100 nm to 10 microns, such as 100 nm to 5 microns, such as 100 nm to 3 microns, such as 100 nm to 1 micron, such as 100 nm to 500 nm, such as 300 nm to 25 mm, such as 300 nm to 15 mm, such as 300 nm to 10 mm, such as 300 nm to 5 mm, such as 300 nm to 1 mm, such as 300 nm to 500 microns, such as 300 nm to 250 microns, such as 300 nm to 200 microns, such as 300 nm to 100 microns, such as 300 nm to 50 microns, such as 300 nm to 30 microns, such as 300 nm to 20 microns, such as 300 nm to 10 microns, such as 300 nm to 5 microns, such as 300 nm to 3 microns, such as 300 nm to 1 micron, such as 300 nm to 500 nm, such as 500 nm to 25 mm, such as 500 nm to 15 mm, such as 500 nm to 10 mm, such as 500 nm to 5 mm, such as 500 nm to 1 mm, such as 500 nm to 500 microns, such as 500 nm to 250 microns, such as 500 nm to 200 microns, such as 500 nm to 100 microns, such as 500 nm to 50 microns, such as 500 nm to 30 microns, such as 500 nm to 20 microns, such as 500 nm to 10 microns, such as 500 nm to 5 microns, such as 500 nm to 3 microns, such as 500 nm to 1 micron, such as 1 micron to 25 mm, such as 1 micron to 15 mm, such as 1 micron to 10 mm, such as 1 micron to 5 mm, such as 1 micron to 1 mm, such as 1 to 500 microns, such as 1 to 250 microns, such as 1 to 200 microns, such as 1 to 100 microns, such as 1 to 50 microns, such as 1 to 30 microns, such as 1 to 20 microns, such as 1 to 10 microns, such as 1 to 5 microns, such as 1 to 3 microns, such as 5 micron to 25 mm, such as 5 micron to 15 mm, such as 5 micron to 10 mm, such as 5 micron to 5 mm, such as 5 microns to 1 mm, such as 5 to 500 microns, such as 5 to 250 microns, such as 5 to 200 microns, such as 5 to 100 microns, such as 5 to 50 microns, such as 5 to 30 microns, such as 5 to 20 microns, such as 5 to 10 microns, such as 10 micron to 25 mm, such as 10 micron to 15 mm, such as 10 micron to 10 mm, such as 10 micron to 5 mm, such as 10 microns to 1 mm, such as 10 to 500 microns, such as 10 to 250 microns, such as 10 to 200 microns, such as 10 to 100 microns, such as 10 to 50 microns, such as 10 to 30 microns, such as 10 to 20 microns, such as 20 micron to 25 mm, such as 20 micron to 15 mm, such as 20 micron to 10 mm, such as 20 micron to 5 mm, such as 20 microns to 1 mm, such as 20 to 500 microns, such as 20 to 250 microns, such as 20 to 200 microns, such as 20 to 100 microns, such as 20 to 50 microns, such as 20 to 30 microns, such as 50 micron to 25 mm, such as 50 micron to 15 mm, such as 50 micron to 10 mm, such as 50 micron to 5 mm, such as 50 microns to 1 mm, such as 50 to 500 microns, such as 50 to 250 microns, such as 50 to 200 microns, such as 50 to 100 microns, such as 100 micron to 25 mm, such as 100 micron to 15 mm, such as 100 micron to 10 mm, such as 100 micron to 5 mm, such as 100 microns to 1 mm, such as 100 to 500 microns, such as 100 to 250 microns, such as 100 to 200 microns, 100 micron to 1 mm, such as 100 to 500 microns, such as 100 to 250 microns, such as 100 to 200 microns, such as 200 micron to 25 mm, such as 200 micron to 15 mm, such as 200 micron to 10 mm, such as 200 micron to 5 mm, such as 200 micron to 1 mm, such as 200 to 500 microns, such as 200 to 250 microns.

The individual carbon nanotubes may have an outer diameter of at least 0.1 nm, such as at least 0.2 nm, such as at least 0.3 nm, such as at least 0.4 nm. The individual carbon nanotubes may have an outer diameter of no more than 100 nm, such as no more than 50 nm, such as no more than 40 nm. The individual carbon nanotubes may have an outer diameter at 0.1 to 100 nm, such as 0.1 to 50 nm, such as 0.1 to 40 nm, such as 0.2 to 100 nm, such as 0.2 to 50 nm, such as 0.2 to 40 nm, such as 0.3 to 100 nm, such as 0.3 to 50 nm, such as 0.3 to 40 nm, such as 0.4 to 100 nm, such as 0.4 to 50 nm, such as 0.4 to 40 nm.

Because of their high aspect ratios, carbon nanotubes are considered to be nearly one-dimensional. For example, the carbon nanotubes may have an aspect ratio (comparison of the length of the carbon nanotube to the outer diameter) of at least 100:1, such as at least 500:1, such as at least 1,000:1, such as at least 10,000:1, such as at least 15,000:1, such as at least 50,000:1. The carbon nanotubes may have an aspect ratio of no more than 100,000,000:1, such as no more than 100,000:1, such as no more than 50,000:1, such as no more than 20,000:1, such as no more than 15,000:1, such as no more than 1,500:1, such as no more than 1,200:1. The carbon nanotubes may have an aspect ratio of 100:1 to 100,000,000:1, such as 100:1 to 100,000:1, such as 100:1 to 50,000:1, such as 100:1 to 20,000:1, such as 100:1 to 15,000:1, such as 100:1 to 1,500:1, such as 100:1 to 1,200:1, such as 500:1 to 100,000,000:1, such as 500:1 to 100,000:1, such as 500:1 to 50,000:1, such as 500:1 to 20,000:1, such as 500:1 to 15,000:1, such as 500:1 to 1,500:1, such as 500:1 to 1,200:1, 1,000:1 to 100,000,000:1, such as 1,000:1 to 100,000:1, such as 1,000:1 to 50,000:1, such as 1,000:1 to 20,000:1, such as 1,000:1 to 15,000:1, such as 1,000:1 to 1,500:1, such as 1,000:1 to 1,200:1, such as 10,000:1 to 100,000,000:1, such as 10,000:1 to 100,000:1, such as 10,000:1 to 50,000:1, such as 10,000:1 to 20,000:1, such as 10,000:1 to 15,000:1, such as 50,000:1 to 100,000,000:1, such as 50,000:1 to 100,000:1.

The carbon nanotubes are present in the dispersion in an amount of at least 0.1% by weight, such as at least 0.5% by weight, such as at least 0.75% by weight, such as at least 1% by weight, such as at least 1.5% by weight, such as at least 2% by weight, such as at least 3% by weight, based on the total solids weight of the dispersion. The carbon nanotubes are present in the dispersion in an amount of no more than 10% by weight, such as no more than 7.5% by weight, such as no more than 5% by weight, such as no more than 4.5% by weight, such as no more than 4% by weight, such as no more than 3.5% by weight, such as no more than 3% by weight, based on the total solids weight of the dispersion. The carbon nanotubes are present in the dispersion in an amount of 0.1% to 10% by weight, such as 0.1% to 7.5% by weight, such as 0.1% to 5% by weight, such as 0.5% to 5% by weight, such as 0.5% to 4.5% by weight, such as 0.75 to 5% by weight, such as 0.75 to 4% by weight, such as 1% to 5% by weight, such as 1% to 4.5%, by weight such as 1% to 4% by weight, such as 1% to 3.5% by weight, such as 1% to 3% by weight, such as 1.5% to 5% by weight, such as 1.5% to 4.5% by weight, such as 1.5% to 4% by weight, such as 2% to 5% by weight, such as 2% to 4.5% by weight, such as 3% to 4% by weight, based on the total solids weight of the dispersion.

According to the present invention, the dispersion further comprises an organic medium. As used herein, the term “organic medium” refers to a liquid medium comprising less than 50% by weight water, based on the total weight of the organic medium. Such organic mediums may comprise less than 40% by weight water, or less than 30% by weight water, or less than 20% by weight water, or less than 10% by weight water, or less than 5% by weight water, or less than 1% by weight water, or less than 0.1% by weight water, based on the total weight of the organic medium, or may be free of water, i.e., 0.00% by weight water. Organic solvent(s) comprise more than 50% by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

The organic medium may comprise, for example, butyl pyrrolidone, trialkyl phosphate, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or combinations thereof. The trialkyl phosphate may comprise, for example, trimethylphosphate, triethylphosphate, tripropylphosphate, tributylphosphate, or the like.

The organic medium may comprise, consist essentially of, or consist of, for example, butyl pyrrolidone, trialkyl phosphate, 1,2,3-triacetoxypropane, 3-methoxy-N,N-dimethylpropanamide, ethyl acetoacetate, gamma-butyrolactone, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), diethylene glycol ethyl ether acetate, or combinations thereof.

The organic medium may comprise a primary solvent and a co-solvent that form a homogenous continuous phase with the carbon nanotubes as the dispersed phase. Both of the primary solvent and co-solvent may comprise organic solvent(s). The primary solvent may comprise, consist essentially of, or consist of, for example, butyl pyrrolidone, a trialkylphosphate, 3-methoxy-N,N-dimethylpropanamide, 1,2,3-triacetoxypropane, or combinations thereof. The co-solvent may comprise, consist essentially of, or consist of, for example, ethyl acetoacetate, gamma-butyrolactone, and/or glycol ethers such as propylene glycol methyl ether, dipropylene glycol methyl ether, propylene glycol monopropyl ether, diethylene glycol monobutyl ether, ethylene glycol monohexyl ether, and the like. The primary solvent may be present in an amount of at least 50% by weight, such as at least 65% by weight, such as at least 75 by weight, and may be present in an amount of no more than 99% by weight, such as no more than 90% by weight, such as no more than 85% by weight, based on the total weight of the organic medium. The primary solvent may be present in an amount of 50% to 99% by weight, such as 65% to 90% by weight, such as 75% to 85% by weight, based on the total weight of the organic medium. The co-solvent may be present in an amount of at least 1% by weight, such as at least 10% by weight, such as at least 15% by weight, and may be present in an amount of no more than 50% by weight, such as no more than 35% by weight, such as no more than 25% by weight. The co-solvent may be present in an amount of 1% to 50% by weight, such as 2% to 40% by weight, such as 5% to 35% by weight, such as 10% to 35% by weight, such as 12.5% to 30% by weight, such as 15% to 25% by weight, based on the total weight of the organic medium.

The organic medium may optionally have an evaporation rate of greater than 80 g/min m², at 180° C., such as greater than 90 g/min m², at 180° C., such as greater than 100 g/min m², at 180° C.

The organic medium may be present in an amount of at least 20% by weight, such as at least 30% by weight, such as at least 40% by weight, such as at least 50% by weight, such as at least 60% by weight, such as at least 70% by weight, such as at least 80% by weight, such as at least 85% by weight, such as at least 87.5% by weight, such as at least 90% by weight, such as at least 91% by weight, such as at least 92% by weight, such as at least 93% by weight, such as at least 94% by weight, such as at least 95% by weight, such as at least 95.5% by weight, such as at least 96% by weight, such as at least 96.5% by weight, such as at least 97% by weight, such as at least 97.5% by weight, such as at least 98% by weight, such as at least 98.5% by weight, such as 99% by weight, such as at least 99.5% by weight, such as 99.9% by weight, based on the total weight of the dispersion. The organic medium may be present in an amount of no more than 99.9% by weight, such as no more than 99% by weight, such as no more than 98% by weight, based on the total weight of the dispersion. The organic medium may be present in an amount of 20% to 99.9%, such as 30% to 99.9%, such as 40% to 99.9%, such as 50% to 99.9%, such as 60% to 99.9%, such as 70% to 99.9%, such as 80% to 99.9%, such as 85% to 99.9%, such as 87.5% to 99.9%, such as 90% to 99.9%, such as 91% to 99.9%, such as 92% to 99.9%, such as 93% to 99.9%, such as 94% to 99.9%, such as 95% to 99.9%, such as 95.5% to 99.9%, such as 96% to 99.9%, such as 96.5% to 99.9%, such as 97% to 99.9%, such as 97.5% to 99.9%, such as 98% to 99.9%, such as 98.5% to 99.9%, such as 90% to 99%, such as 91% to 99%, such as 92% to 99%, such as 93% to 99%, such as 94% to 99%, such as 95% to 99%, such as 95.5% to 99%, such as 96% to 99%, such as 96.5% to 99%, such as 97% to 99%, such as 97.5% to 99%, such as 98% to 99%, such as 98.5% to 99%, such as 90% to 98%, such as 91% to 98%, such as 92% to 98%, such as 93% to 98%, such as 94% to 98%, such as 95% to 98%, such as 95.5% to 98%, such as 96% to 98%, such as 96.5% to 98%, based on the total weight of the dispersion.

The dispersion further comprises a dispersant. The dispersant assists in dispersing the carbon nanotubes. The dispersant may comprise at least one phase that is compatible with the carbon nanotubes and may further comprise at least one phase that is compatible with the organic medium. For example, the dispersant may be comprised of two distinct functionalities: a reactive group and a tail group. The reactive group may include silanes, carboxylic acids, sulfonic acid groups, phosphonic acids, heterocycles (e.g.: pyridine, imidazole, epoxides, etc.), quaternary phosphonium ions and quaternary ammonium ion, groups capable of hydrogen bonding such an oxygen, nitrogen, sulfur or fluorine-containing groups (e.g., hydroxyl, amine, etc.), or salts thereof. As used herein, a “reactive group” with respect to the dispersant is defined as a functional group that can interact with the surface of the carbon nanotube either through chemical reaction, ion pairing, hydrogen bonding, dispersion forces, or chemical absorption. The tail group comprises a second functionality that helps to prevent the interaction of carbon nanotubes with each other and therefore prevents agglomeration and facilitates dispersion/deagglomeration.

The dispersion may comprise one, two, three, four or more different dispersants. The dispersant may comprise any material having phases compatible with both the carbon nanotubes and the organic medium. As used herein, the term “compatible” means the ability of a material to form a blend with other materials that is and will remain substantially homogenous over time. For example, the dispersant may comprise a polymer, a surfactant, an ionic liquid, a biomacromolecule, or any combination thereof.

The dispersant may comprise a polymer in the form of a block polymer, a random polymer, or a gradient polymer, wherein the phases of present in the different blocks of the polymer, are randomly included throughout the polymer, or are progressively more or less densely present along the polymer backbone, respectively. The dispersant may comprise any suitable polymer to serve this purpose. For example, the polymer may comprise addition polymers produced by polymerizing ethylenically unsaturated monomers, polyepoxide polymers, polyamide polymers, polyurethane polymers, polyurea polymers, polyether polymers, polyacid polymers, and polyester polymers, among others. The dispersant may also serve as an additional component of the binder of a slurry composition that incorporates the dispersion of the present invention.

The reactive group of the dispersant may comprise a variety of functional groups. The functional groups may comprise, for example, active hydrogen functional groups, heterocyclic groups, and combinations thereof. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, lactams and lactones. In addition, when epoxide functional groups are present on the addition polymer, the epoxide functional groups on the dispersant may be post-reacted with a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the dispersant.

When acid functional groups are present, the dispersant may have a theoretical acid equivalent weight of at least 350 g/acid equivalent, such as at least 878 g/acid equivalent, such as at least 1,757 g/acid equivalent, and may be no more than 17,570 g/acid equivalent, such as no more than 12,000 g/acid equivalent, such as no more than 7,000 g/acid equivalent. The dispersant may have a theoretical acid equivalent weight of 350 to 17,570 g/acid equivalent, such as 878 to 12,000 g/acid equivalent, such as 1,757 to 7,000 g/acid equivalent.

As mentioned above, the dispersant may comprise an addition polymer. The addition polymer may be derived from, and comprise constitutional units comprising the residue of, one or more alpha, beta-ethylenically unsaturated monomers, such as those discussed below, and may be prepared by polymerizing a reaction mixture of such monomers. The mixture of monomers may comprise one or more active hydrogen group-containing ethylenically unsaturated monomers. The reaction mixture may also comprise ethylenically unsaturated monomers comprising a heterocyclic group. As used herein, an ethylenically unsaturated monomer comprising a heterocyclic group refers to a monomer having at least one alpha, beta ethylenic unsaturated group and at least cyclic moiety having at least one atom in addition to carbon in the ring structure, such as, for example, oxygen, nitrogen or sulfur. Non-limiting examples of ethylenically unsaturated monomers comprising a heterocyclic group include epoxy functional ethylenically unsaturated monomers, vinyl pyrrolidone and vinyl caprolactam, among others. The reaction mixture may additionally comprise other ethylenically unsaturated monomers such as alkyl esters of (meth)acrylic acid and others described below.

The addition polymer may comprise a (meth)acrylic polymer that comprises constitutional units comprising the residue of one or more (meth)acrylic monomers. The (meth)acrylic polymer may be prepared by polymerizing a reaction mixture of alpha, beta-ethylenically unsaturated monomers that comprise one or more (meth)acrylic monomers and optionally other ethylenically unsaturated monomers. As used herein, the term “(meth)acrylic monomer” refers to acrylic acid, methacrylic acid, and monomers derived therefrom, including alkyl esters of acrylic acid and methacrylic acid, and the like. As used herein, the term “(meth)acrylic polymer” refers to a polymer derived from or comprising constitutional units comprising the residue of one or more (meth)acrylic monomers. The mixture of monomers may comprise one or more active hydrogen group-containing (meth)acrylic monomers, ethylenically unsaturated monomers comprising a heterocyclic group, and other ethylenically unsaturated monomers. The (meth)acrylic polymer may also be prepared with an epoxy functional ethylenically unsaturated monomer such as glycidyl methacrylate in the reaction mixture, and epoxy functional groups on the resulting polymer may be post-reacted with a beta-hydroxy functional acid such as citric acid, tartaric acid, and/or 3-hydroxy-2-naphthoic acid to yield hydroxyl functional groups on the (meth)acrylic polymer.

The addition polymer may comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 1% by weight, such as at least 2% by weight, such as at least 5% by weight, and may be no more than 50% by weight, such as no more than 20% by weight, such as no more than 10% by weight, such as no more than 5% by weight, based on the total weight of the addition polymer. The constitutional units comprising the residue of the alpha, beta-ethylenically unsaturated carboxylic acids may comprise 1% to 50% by weight, 2% to 50% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the alpha, beta-ethylenically unsaturated carboxylic acids in an amount of 1% to 50% by weight, 2% to 50% by weight, such as 2% to 20% by weight, such as 2% to 10% by weight, such as 2% to 5% by weight, such as 1% to 5% by weight, based on the total weight of polymerizable monomers used in the reaction mixture. The inclusion of constitutional units comprising the residue of an alpha, beta-ethylenically unsaturated carboxylic acids in the dispersant results in a dispersant comprising at least one carboxylic acid group which may assist in providing stability to the dispersion.

The addition polymer may comprise constitutional units comprising the residue of an alkyl esters of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 20% by weight, such as at least 30% by weight, such as at least 40% by weight, such as at least 45% by weight, such as at least 50% by weight, and may be no more than 98% by weight, such as no more than 96% by weight, such as no more than 90% by weight, such as no more than 80% by weight, such as no more than 75% by weight, based on the total weight of the addition polymer. The constitutional units comprising the residue of the alkyl esters of (meth)acrylic acid containing from 1 to 3 carbon atoms in the alkyl group may comprise 20% to 98% by weight, such as 30% to 96% by weight, such as 30% to 90% by weight, 40% to 90% by weight, such as 40% to 80% by weight, such as 45% to 75% by weight, based on the total weight of the addition polymer. The addition polymer may be derived from a reaction mixture comprising the alkyl esters of (meth)acrylic acid containing from 1 to 3 carbon atoms in the alkyl group in an amount of 20% to 98% by weight, such as 30% to 96% by weight, such as 30% to 90% by weight, 40% to 90% by weight, such as 40% to 80% by weight, such as 45% to 75% by weight, based on the total weight of polymerizable monomers used in the reaction mixture.

The addition polymer may comprise constitutional units comprising the residue of an alkyl esters of (meth)acrylic acid containing from 4 to 7 carbon atoms in the alkyl group. Non-limiting examples of alkyl esters of (meth)acrylic acid containing from 4 to 22 carbon atoms in the alkyl group include butyl (meth)acrylate, pentyl (meth)acrylate, hexyl (meth)acrylate, and heptyl (meth)acrylate. The constitutional units comprising the residue of the alkyl esters of (meth)acrylic acid containing from 4 to 7 carbon atoms in the alkyl group may comprise at least 2% by weight, such as at least 5% by weight, such as at least 10% by weight, such as at least 15% by weight, such as at least 20% by weight, and may be no more than 70% by weight, such as no more than 60% by weight, such as no more than 50% by weight, such as no more than 40% by weight, such as no more than 35% by weight, such as no more than 25% by weight, such as no more than 20% by weight, based on the total weight of the addition polymer. The constitutional units comprising the residue of the alkyl esters of (meth)acrylic acid containing from 4 to 7 carbon atoms in the alkyl group may comprise 2% to 70% by weight, such as 2% to 60% by weight, such as 2% to 50% by weight, such as 2% to 40% by weight, such as 2% to 35% by weight, such as 2% to 25% by weight, such as 2% to 20% by weight, such as 5% to 70% by weight, such as 5% to 60% by weight, such as 5% to 50% by weight, such as 5% to 40% by weight, such as 5% to 35% by weight, such as 5% to 25% by weight, such as 5% to 20% by weight, such as 10% to 70% by weight, such as 10% to 60% by weight, such as 10% to 50% by weight, such as 10% to 40% by weight, such as 10% to 35% by weight, such as 10% to 25% by weight, such as 10% to 20% by weight, such as 15% to 70% by weight, such as 15% to 60% by weight, such as 15% to 50% by weight, such as 15% to 40% by weight, such as 15% to 35% by weight, such as 15% to 25% by weight, such as 15% to 20% by weight, such as 20% to 70% by weight, such as 20% to 60% by weight, such as 20% to 50% by weight, such as 20% to 40% by weight, such as 20% to 35% by weight, such as 20% to 25% by weight, based on the total weight of the addition polymer. The addition polymer may be derived from a reaction mixture comprising the alkyl esters of (meth)acrylic acid containing from 4 to 7 carbon atoms in the alkyl group in an amount of 2% to 70% by weight, such as 2% to 60% by weight, such as 2% to 50% by weight, such as 2% to 40% by weight, such as 2% to 35% by weight, such as 2% to 25% by weight, such as 2% to 20% by weight, such as 5% to 70% by weight, such as 5% to 60% by weight, such as 5% to 50% by weight, such as 5% to 40% by weight, such as 5% to 35% by weight, such as 5% to 25% by weight, such as 5% to 20% by weight, such as 10% to 70% by weight, such as 10% to 60% by weight, such as 10% to 50% by weight, such as 10% to 40% by weight, such as 10% to 35% by weight, such as 10% to 25% by weight, such as 10% to 20% by weight, such as 15% to 70% by weight, such as 15% to 60% by weight, such as 15% to 50% by weight, such as 15% to 40% by weight, such as 15% to 35% by weight, such as 15% to 25% by weight, such as 15% to 20% by weight, such as 20% to 70% by weight, such as 20% to 60% by weight, such as 20% to 50% by weight, such as 20% to 40% by weight, such as 20% to 35% by weight, such as 20% to 25% by weight, based on the total weight of polymerizable monomers used in the reaction mixture.

The addition polymer may comprise constitutional units comprising the residue of an alkyl esters of (meth)acrylic acid containing from 8 to 22 carbon atoms in the alkyl group. Non-limiting examples of alkyl esters of (meth)acrylic acid containing from 8 to 22 carbon atoms in the alkyl group include octyl (meth)acrylate, isodecyl (meth)acrylate, stearyl (meth)acrylate, 2-ethylhexyl (meth)acrylate, decyl (meth)acrylate, and dodecyl (meth)acrylate (lauryl (meth)acrylate). The constitutional units comprising the residue of the alkyl esters of (meth)acrylic acid containing from 8 to 22 carbon atoms in the alkyl group may comprise at least 2% by weight, such as at least 5% by weight, such as at least 10% by weight, such as at least 15% by weight, such as at least 20% by weight, and may be no more than 70% by weight, such as no more than 60% by weight, such as no more than 50% by weight, such as no more than 40% by weight, such as no more than 35% by weight, such as no more than 25% by weight, such as no more than 20% by weight, based on the total weight of the addition polymer. The constitutional units comprising the residue of the alkyl esters of (meth)acrylic acid containing from 8 to 22 carbon atoms in the alkyl group may comprise 2% to 70% by weight, such as 2% to 60% by weight, such as 2% to 50% by weight, such as 2% to 40% by weight, such as 2% to 35% by weight, such as 2% to 25% by weight, such as 2% to 20% by weight, such as 5% to 70% by weight, such as 5% to 60% by weight, such as 5% to 50% by weight, such as 5% to 40% by weight, such as 5% to 35% by weight, such as 5% to 25% by weight, such as 5% to 20% by weight, such as 10% to 70% by weight, such as 10% to 60% by weight, such as 10% to 50% by weight, such as 10% to 40% by weight, such as 10% to 35% by weight, such as 10% to 25% by weight, such as 10% to 20% by weight, such as 15% to 70% by weight, such as 15% to 60% by weight, such as 15% to 50% by weight, such as 15% to 40% by weight, such as 15% to 35% by weight, such as 15% to 25% by weight, such as 15% to 20% by weight, such as 20% to 70% by weight, such as 20% to 60% by weight, such as 20% to 50% by weight, such as 20% to 40% by weight, such as 20% to 35% by weight, such as 20% to 25% by weight, based on the total weight of the addition polymer. The addition polymer may be derived from a reaction mixture comprising the alkyl esters of (meth)acrylic acid containing from 8 to 22 carbon atoms in the alkyl group in an amount of 2% to 70% by weight, such as 2% to 60% by weight, such as 2% to 50% by weight, such as 2% to 40% by weight, such as 2% to 35% by weight, such as 2% to 25% by weight, such as 2% to 20% by weight, such as 5% to 70% by weight, such as 5% to 60% by weight, such as 5% to 50% by weight, such as 5% to 40% by weight, such as 5% to 35% by weight, such as 5% to 25% by weight, such as 5% to 20% by weight, such as 10% to 70% by weight, such as 10% to 60% by weight, such as 10% to 50% by weight, such as 10% to 40% by weight, such as 10% to 35% by weight, such as 10% to 25% by weight, such as 10% to 20% by weight, such as 15% to 70% by weight, such as 15% to 60% by weight, such as 15% to 50% by weight, such as 15% to 40% by weight, such as 15% to 35% by weight, such as 15% to 25% by weight, such as 15% to 20% by weight, such as 20% to 70% by weight, such as 20% to 60% by weight, such as 20% to 50% by weight, such as 20% to 40% by weight, such as 20% to 35% by weight, such as 20% to 25% by weight, based on the total weight of polymerizable monomers used in the reaction mixture.

The addition polymer alternatively may be substantially free, essentially free, or completely free of constitutional units comprising the residue of an alkyl esters of (meth)acrylic acid containing from 8 to 22 carbon atoms in the alkyl group. An addition polymer is “substantially free” of constitutional units comprising the residue of an alkyl esters of (meth)acrylic acid containing from 8 to 22 carbon atoms in the alkyl group if such constitutional units are present in an amount of less than 3% by weight, based on the total weight of the addition polymer. An addition polymer is “essentially free” of constitutional units comprising the residue of an alkyl esters of (meth)acrylic acid containing from 8 to 22 carbon atoms in the alkyl group if such constitutional units are present in an amount of less than 1% by weight, based on the total weight of the addition polymer. An addition polymer is “completely free” of constitutional units comprising the residue of an alkyl esters of (meth)acrylic acid containing from 8 to 22 carbon atoms in the alkyl group if such constitutional units are not present in the addition polymer, i.e., 0.0% by weight, based on the total weight of the addition polymer.

The addition polymer may comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the hydroxyalkyl ester may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the hydroxyalkyl ester in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture. The inclusion of constitutional units comprising the residue of a hydroxyalkyl ester in the dispersant results in a dispersant comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the addition polymer when self-crosslinking monomers that have groups that are reactive with the hydroxyl groups are incorporated into the addition polymer.

The addition polymer may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers, such as glycidyl (meth)acrylate, vinyl pyrrolidone and vinyl caprolactam, vinyl pyridine among others. The constitutional units comprising the residue of the ethylenically unsaturated monomers comprising a heterocyclic group may comprise at least 0.5% by weight, such as at least 1% by weight, such as at least 5% by weight, such as at least 8% by weight, and may be no more than 99% by weight, such as no more than 50% by weight, such as no more than 40% by weight, such as no more than 30% by weight, such as no more than 27% by weight, based on the total weight of the addition polymer. The constitutional units comprising the residue of the ethylenically unsaturated monomers comprising a heterocyclic group may comprise 0.5% to 99% by weight, such as 0.5% to 50% by weight, such as 1% to 40% by weight, such as 5% to 30% by weight, 8% to 27% by weight, based on the total weight of the addition polymer. The addition polymer may be derived from a reaction mixture comprising the ethylenically unsaturated monomers comprising a heterocyclic group in an amount of 0.5% to 50% by weight, such as 1% to 40% by weight, such as 5% to 30% by weight, 8% to 27% by weight, based on the total weight of polymerizable monomers used in the reaction mixture.

As noted above, the addition polymer may comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with other functional groups present on the dispersant to a crosslink between the dispersant or more than one dispersant. Non-limiting examples of self-crosslinking monomers include N-alkoxymethyl (meth)acrylamide monomers such as N-butoxymethyl (meth)acrylamide and N-isopropoxymethyl (meth)acrylamide, as well as self-crosslinking monomers containing blocked isocyanate groups, such as isocyanatoethyl (meth)acrylate in which the isocyanato group is reacted (“blocked”) with a compound that unblocks at curing temperature. Examples of suitable blocking agents include epsilon-caprolactone and methylethyl ketoxime. The constitutional units comprising the residue of the self-crosslinking monomer may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the self-crosslinking monomer may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the self-crosslinking monomer in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The addition polymer may comprise constitutional units comprising the residue of other functionalized alpha, beta-ethylenically unsaturated monomers comprising phosphonic acids, phosphate ester, sulfonic acids, sulfonic esters, phosphinic acids, phosphinic esters, sulfinic acids, or sulfinic esters. The constitutional units comprising the residue of such monomers may comprise at least 1% by weight, such as at least 2% by weight, such as at least 5% by weight, and may be no more than 50% by weight, such as no more than 40% by weight, such as no more than 30% by weight, such as no more than 20% by weight, such as no more than 10% by weight, such as no more than 5% by weight, based on the total weight of the addition polymer. The constitutional units comprising the residue of such monomers may comprise 1% to 50% by weight, such as 1% to 40% by weight, such as 1% to 30% by weight, such as 1% to 10% by weight, such as 2% to 50% by weight, such as 2% to 40% by weight, such as no more than 2% to 30% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the alpha, beta-ethylenically unsaturated monomers comprising phosphonic acids, phosphate ester, sulfonic acids, sulfonic esters, phosphinic acids, phosphinic esters, sulfinic acids, or sulfinic esters in an amount of 1% to 50% by weight, such as 1% to 40% by weight, such as 1% to 30% by weight, 1% to 10% by weight, 2% to 50% by weight, such as 2% to 40% by weight, such as no more than 2% to 30% by weight, such as 2% to 20% by weight, such as 2% to 10% by weight, such as 2% to 5% by weight, such as 1% to 5% by weight, based on the total weight of polymerizable monomers used in the reaction mixture.

The addition polymer may comprise constitutional units comprising the residue of an unsaturated silane group-containing monomer. Non-limiting examples of unsaturated silane group-containing monomers include vinyl trialkoxysilane, such as vinyl trimethoxysilane, vinyl triethoxysilane, or a combination thereof. The constitutional units comprising the residue of unsaturated silane group-containing monomers may comprise at least 1% by weight, such as at least 2% by weight, such as at least 5% by weight, and may be no more than 50% by weight, such as no more than 40% by weight, such as no more than 30% by weight, such as no more than 20% by weight, such as no more than 10% by weight, such as no more than 5% by weight, based on the total weight of the addition polymer. The constitutional units comprising the residue of unsaturated silane group-containing monomers may comprise 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the unsaturated silane group-containing monomers in an amount of 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of polymerizable monomers used in the reaction mixture.

The addition polymer may comprise constitutional units comprising the residue of a vinyl alkyl oxazolidinone monomer. Non-limiting examples of vinyl alkyl oxazolidinone monomers include vinyl methyl oxazolidinone (VMOX), vinyl ethyl oxazolidinone, or the like The constitutional units comprising the residue of vinyl alkyl oxazolidinone monomers may comprise at least 1% by weight, such as at least 2% by weight, such as at least 5% by weight, and may be no more than 50% by weight, such as no more than 40% by weight, such as no more than 30% by weight, such as no more than 20% by weight, such as no more than 10% by weight, such as no more than 5% by weight, based on the total weight of the addition polymer. The constitutional units comprising the residue of vinyl alkyl oxazolidinone monomers may comprise 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the vinyl alkyl oxazolidinone monomers in an amount of 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of polymerizable monomers used in the reaction mixture.

The addition polymer may comprise constitutional units comprising the residue of poly(alkylene glycol) methyl ether (meth)acrylate monomer. Non-limiting examples of poly(alkylene glycol) methyl ether (meth)acrylate monomers include poly(ethylene glycol) methyl ether (meth)acrylate monomer, poly(propylene glycol) methyl ether (meth)acrylate monomer, or the like The constitutional units comprising the residue of poly(alkylene glycol) methyl ether (meth)acrylate monomers may comprise at least 1% by weight, such as at least 2% by weight, such as at least 5% by weight, and may be no more than 50% by weight, such as no more than 40% by weight, such as no more than 30% by weight, such as no more than 20% by weight, such as no more than 10% by weight, such as no more than 5% by weight, based on the total weight of the addition polymer. The constitutional units comprising the residue of poly(alkylene glycol) methyl ether (meth)acrylate monomers may comprise 1% to 50% by weight, such as 1% to 40% by weight, such as 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the poly(alkylene glycol) methyl ether (meth)acrylate monomers in an amount of 1% to 50% by weight, such as 1% to 40% by weight, such as 1% to 30% by weight, such as 1% to 10% by weight, 2% to 50% by weight, such as 2% to 40% by weight, such as 2% to 30% by weight, such as 2% to 20% by weight, such as 2% to 10% by weight, such as 2% to 5% by weight, such as 1% to 5% by weight, based on the total weight of polymerizable monomers used in the reaction mixture.

The addition polymer may comprise constitutional units comprising the residue of other alpha, beta-ethylenically unsaturated monomers. Non-limiting examples of other alpha, beta-ethylenically unsaturated monomers include vinyl aromatic compounds such as styrene, alpha-methyl styrene, alpha-chlorostyrene and vinyl toluene; organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the other alpha, beta-ethylenically unsaturated monomers may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the other alpha, beta-ethylenically unsaturated monomers in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The addition polymer may also comprise polyvinyl pyrrolidone.

The addition polymer may also comprise linear or acyclic amide polymers. Non-limiting examples thereof include poly(2-ethyl-2-oxazoline) (PEOX).

The addition polymer may also comprise an alkali-swellable rheology modifier such as alkali-swellable emulsions (ASE), hydrophobically modified alkali-swellable emulsions (HASE), ATRP star polymers, and other materials that provide pH-triggered rheological changes. The alkali-swellable rheology modifiers may comprise addition polymers having constitutional units comprising the residue of ethylenically unsaturated monomers. For example, the alkali-swellable rheology modifiers may comprise addition polymers having constitutional units comprising, consisting essentially of, or consisting of the residue of: (a) 2 to 70% by weight of a monoethylenically unsaturated carboxylic acid, such as 20 to 70% by weight, such as 25 to 55% by weight, such as 35 to 55% by weight, such as 40 to 50% by weight, such as 45 to 50% by weight; (b) 20 to 80% by weight of a C₁ to C₆ alkyl (meth)acrylate, such as 35 to 65% by weight, such as 40 to 60% by weight, such as 40 to 50% by weight, such as 45 to 50% by weight; and at least one of (c) 0 to 3% by weight of a crosslinking monomer, such as 0.1 to 3% by weight, such as 0.1 to 2% by weight; and/or (d) 0 to 60% by weight of a monoethylenically unsaturated alkyl alkoxylate monomer, such as 0.5 to 60% by weight, such as 10 to 50% by weight, the % by weight being based on the total weight of the addition polymer. The ASE rheology modifiers may comprise (a) and (b) and may optionally further comprise (c), and the HASE rheology modifiers may comprise (a), (b) and (d), and may optionally further comprise (c). When (c) is present, the pH-dependent rheology modifier may be referred to as a crosslinked pH-dependent rheology modifier. When the acid groups have a high degree of protonation (i.e., are un-neutralized) at low pH, the rheology modifier is insoluble in water and does not thicken the composition, whereas when the acid is substantially deprotonated (i.e., substantially neutralized) at higher pH values, the rheology modifier becomes soluble or dispersible (such as micelles or microgels) and thickens the composition.

The (a) monoethylenically unsaturated carboxylic acid may comprise a C₃ to C₈ monoethylenically unsaturated carboxylic acid such as acrylic acid, methacrylic acid, and the like, as well as combinations thereof.

The (b) C₁ to C₈ alkyl (meth)acrylate may comprise a C₁ to C₆ alkyl (meth)acrylate, such as a C₁ to C₄ alkyl (meth)acrylate. The C₁ to C₈ alkyl (meth)acrylate may comprise a non-substituted C₁ to C₈ alkyl (meth)acrylate such as, for example, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isopentyl (meth)acrylate, hexyl (meth)acrylate, heptyl (meth)acrylate, isoheptyl (meth)acrylate, 2-ethylhexyl (meth)acrylate, or combinations thereof.

The (c) crosslinking monomer may comprise a polyethylenically unsaturated monomer such as ethylene glycol di(meth)acrylate, 1,6-hexanediol di(meth)acrylate, divinylbenzene, trimethylolpropane diallyl ether, tetraallyl pentaerythritol, triallyl pentaerythritol, diallyl pentaerythritol, diallyl phthalate, triallyl cyanurate, bisphenol A diallyl ether, methylene bisacrylamide, allyl sucroses, and the like, as well as combinations thereof.

The (d) monoethylenically unsaturated alkylated ethoxylate monomer may comprise a monomer having a polymerizable group, a hydrophobic group and a bivalent polyether group of a poly(alkylene oxide) chain, such as a poly(ethylene oxide) chain having about 5-150 ethylene oxide units, such as 6-10 ethylene oxide units, and optionally 0-5 propylene oxide units. The hydrophobic group is typically an alkyl group having 6-22 carbon atoms (such as a dodecyl group) or an alkaryl group having 8-22 carbon atoms (such as octyl phenol). The bivalent polyether group typically links the hydrophobic group to the polymerizable group. Examples of the bivalent polyether group linking group and hydrophobic group are a bicycloheptyl-polyether group, a bicycloheptenyl-polyether group or a branched C₅-C₅₀ alkyl-polyether group, wherein the bicycloheptyl-polyether or bicycloheptenyl-polyether group may optionally be substituted on one or more ring carbon atoms by one or two C₁-C₆ alkyl groups per carbon atom.

In addition to the monomers described above, the alkali-swellable rheology modifier may comprise other ethylenically unsaturated monomers. Examples thereof include substituted alkyl (meth)acrylate monomers substituted with functional groups such as hydroxyl, amino, amide, glycidyl, thiol, and other functional groups; alkyl (meth)acrylate monomers containing fluorine; aromatic vinyl monomers; and the like. Alternatively, the alkali-swellable rheology modifier may be substantially free, essentially free, or completely free of such monomers. As used herein, an alkali-swellable rheology modifier is substantially free or essentially free of a monomer when constitutional units of that monomer are present, if at all, in an amount of less than 0.1% by weight or less than 0.01% by weight, respectively, based on the total weight of the alkali-swellable rheology modifier.

The monomers and relative amounts may be selected such that the resulting addition polymer has a Tg of 100° C. or less. The resulting addition polymer may have a Tg of, for example, at least -50° C., such as at least -40° C., such as -30° C., such as, -20° C., such as -15° C., such as -10° C., such as -5° C., such as 0° C. The resulting addition polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting addition polymer may have a Tg of, for example, -50 to +70° C., such as -50 to +60° C., such as -50 to +50° C., such as -50 to +40° C., such as -50 to +25° C., such as -50 to +20° C., such as -50 to +15° C., such as -50 to +10° C., such as -50 to +5° C., such as -50 to 0° C., such as -40 to +50° C., such as -40 to +40° C., such as -40 to +25° C., such as -40 to +20° C., such as -40 to +15° C., such as -40 to +10° C., such as -40 to +5° C., such as -40 to 0° C., such as -30 to +50° C., such as -30 to +40° C., such as -30 to +25° C., such as -30 to +20° C., such as -30 to +15° C., such as -30 to +10° C., such as -30 to +5° C., such as -30 to 0° C., such as -20 to +50° C., such as -20 to +40° C., such as -20 to +25° C., such as -20 to +20° C., such as -20 to +15° C., such as -20 to +10° C., such as -20 to +5° C., such as -20 to 0° C., such as -15 to +50° C., such as -15 to +40° C., such as -15 to +25° C., such as -15 to +20° C., such as -15 to +15° C., such as -15 to +10° C., such as -15 to +5° C., such as -15 to 0° C., such as -10 to +50° C., such as -10 to +40° C., such as -10 to +25° C., such as -10 to +20° C., such as -10 to +15° C., such as -10 to +10° C., such as -10 to +5° C., such as -10 to 0° C., such as -5 to +50° C., such as -5 to +40° C., such as -5 to +25° C., such as -5 to +20° C., such as -5 to +15° C., such as -5 to +10° C., such as -5 to +5° C., such as -5 to 0° C., such as -0 to +50° C., such as -0 to +40° C., such as -0 to +25° C., such as -0 to +20° C., such as -0 to +15° C. A lower Tg that is below 0° C. may be desirable to ensure acceptable battery performance at low temperature.

The addition polymers may be prepared by conventional free radical initiated solution polymerization techniques in which the polymerizable monomers are dissolved in an organic medium comprising a solvent or a mixture of solvents and polymerized in the presence of a free radical initiator until conversion is complete. The organic medium used to produce the addition polymer may comprise any suitable organic solvent or mixture of solvents, including those discussed above with respect to the organic medium, such as, for example, a trialkyl phosphate such as triethylphosphate.

Examples of free radical initiators are those which are soluble in the mixture of monomers such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications. Tertiary-dodecyl mercaptan is preferred because it results in high conversion of monomer to polymeric product.

To prepare the addition polymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

The addition polymer may also be prepared using anionic and/or cationic polymerization.

As mentioned above, the dispersant may comprise a surfactant. The surfactant may comprise any suitable surfactant, such as anionic surfactants or cationic surfactants.

As mentioned above, the dispersant may comprise an ionic liquid. Ionic liquids are salts that are liquid at temperatures less than or equal to 400° C., such as at temperatures less than 100° C., such as at temperatures less than or equal to 75° C., such as at temperatures less than or equal to room temperature (i.e., 25° C.) at atmospheric pressure (101,325 Pa). Ionic liquids comprise a cation and an anion. Suitable cations may include, for example, imidazolium; pyridinium; pyrrolidinium; phosphonium; ammonium; guanidinium; isouronium; thiouronium; and sulphonium groups. Suitable anions may include, for example, a halide such as fluoride, chloride, bromide and iodide; tetrafluoroborate; hexafluorophosphate; bis(trifluoromethylsulfonyl)imide; tris(pentafluoroethyl)trifluorophosphate (FAPs); trifluoromethanesulfonate; trifluoroacetate; methylsulfate; octylsulfate; thiocyanate; organoborate; p-toluenesulfonate, perchlorate, and dicyanamide. The ionic liquid may comprise any combination of the above cation(s) and anion(s), and other suitable cations or anions not listed may be used. Specific non-limiting examples include 1-butyl-3-methylimidazolium hexfluorophosphate, 1-butyl-3-methylimidazolium tetrafluoroborate, or a combination thereof.

As mentioned above, the dispersant may comprise a biomacromolecule. The biomacromolecule may comprise DNA, chitosan, glucose oxidase, or a combination thereof.

The dispersants may have a number average molecular weight of at least 2,500 g/mol, such as at least 5,000 g/mol, such as at least 7,500 g/mol, such at least 10,000 g/mol. The dispersants may have a number average molecular weight of no more than 100,000 g/mol, such as no more than 75,000 g/mol, such as no more than 50,000 g/mol, such as no more than 25,000 g/mol, such as no more than 20,000 g/mol, such as no more than 15,000 g/mol, such as no more than 10,000 g/mol, such as no more than 7,500 g/mol. The dispersants may have a number average molecular weight of 2,500 to 100,000 g/mol, such as 2,500 to 75,000 g/mol, such as 2,500 to 50,000 g/mol, such as 2,500 to 25,000 g/mol, such as 2,500 to 20,000 g/mol, such as 2,500 to 15,000 g/mol, such as 2,500 to 12,500 g/mol, such as 2,500 to 10,000 g/mol, such as 2,500 to 7,500 g/mol, 5,000 to 100,000 g/mol, such as 5,000 to 75,000 g/mol, such as 5,000 to 50,000 g/mol, such as 5,000 to 25,000 g/mol, such as 5,000 to 20,000 g/mol, such as 5,000 to 15,000 g/mol, such as 5,000 to 12,500 g/mol, such as 5,000 to 10,000 g/mol, such as 5,000 to 7,500 g/mol, 7,500 to 100,000 g/mol, such as 7,500 to 75,000 g/mol, such as 7,500 to 50,000 g/mol, such as 7,500 to 25,000 g/mol, such as 7,500 to 20,000 g/mol, such as 7,500 to 15,000 g/mol, such as 7,500 to 12,500 g/mol, such as 7,500 to 10,000 g/mol, 10,000 to 100,000 g/mol, such as 10,000 to 75,000 g/mol, such as 10,000 to 50,000 g/mol, such as 10,000 to 25,000 g/mol, such as 10,000 to 20,000 g/mol, such as 10,000 to 15,000 g/mol, such as 10,000 to 12,500 g/mol.

The dispersants may have a weight average molecular weight of at least at least 5,000 g/mol, such as at least 10,000 g/mol, such as at least 15,000 g/mol, such at least 20,000 g/mol. The dispersants may have a weight average molecular weight of no more than 200,000 g/mol, such as no more than 150,000 g/mol, such as no more than 100,000 g/mol, such as no more than 50,000 g/mol, such as no more than 40,000 g/mol, such as no more than 30,000 g/mol, such as no more than 20,000 g/mol, such as no more than 15,000 g/mol. The dispersants may have a weight average molecular weight of 5,000 to 200,000 g/mol, such as 5,000 to 150,000 g/mol, such as 5,000 to 100,000 g/mol, such as 5,000 to 50,000 g/mol, such as 5,000 to 40,000 g/mol, such as 5,000 to 30,000 g/mol, such as 5,000 to 25,000 g/mol, such as 5,000 to 20,000 g/mol, such as 5,000 to 15,000 g/mol, 10,000 to 200,000 g/mol, such as 10,000 to 150,000 g/mol, such as 10,000 to 100,000 g/mol, such as 10,000 to 50,000 g/mol, such as 10,000 to 40,000 g/mol, such as 10,000 to 30,000 g/mol, such as 10,000 to 25,000 g/mol, such as 10,000 to 20,000 g/mol, such as 10,000 to 15,000 g/mol, 15,000 to 200,000 g/mol, such as 15,000 to 150,000 g/mol, such as 15,000 to 100,000 g/mol, such as 15,000 to 50,000 g/mol, such as 15,000 to 40,000 g/mol, such as 15,000 to 30,000 g/mol, such as 15,000 to 25,000 g/mol, such as 15,000 to 20,000 g/mol, 20,000 to 200,000 g/mol, such as 20,000 to 150,000 g/mol, such as 20,000 to 100,000 g/mol, such as 20,000 to 50,000 g/mol, such as 20,000 to 40,000 g/mol, such as 20,000 to 30,000 g/mol, such as 20,000 to 25,000 g/mol.

The dispersant may be present in the dispersion in amounts of at least 0.5% by weight, such as at least 1% by weight, such as at least 2% by weight, such as at least 3% by weight, such as at least 4% by weight, such as at least 5% by weight, such as at least 10% by weight, such as at least 15% by weight, such as at least 20% by weight, based on the total solids weight of the dispersion. The dispersant may be present in the dispersion in amounts of no more than 40% by weight, such as no more than 30% by weight, such as no more than 25% by weight, based on the total solids weight of the dispersion. The dispersant may be present in the dispersion in amounts of 0.5% to 40% by weight, such as 1% to 40% by weight, such as 2% to 40% by weight, such as 3% to 40% by weight, such as 4% to 40% by weight, such as 5% to 40% by weight, such as 10% to 40% by weight, such as 15% to 40% by weight, such as 20% to 40% by weight, such as 0.5% to 30% by weight, such as 1% to 30% by weight, such as 2% to 30% by weight, such as 3% to 30% by weight, such as 4% to 30% by weight, such as 5% to 30% by weight, such as 10% to 30% by weight, such as 15% to 30% by weight, such as 20% to 30% by weight, such as 0.5% to 25% by weight, such as 1% to 25% by weight, such as 2% to 25% by weight, such as 3% to 25%, such as 4% to 25% by weight, such as 5% to 25% by weight, such as 10% to 25% by weight, such as 15% to 25% by weight, such as 20% to 25% by weight, based on the total solids weight of the dispersion.

The weight ratio of carbon nanotubes to dispersant may be 250:1 to 1:1, such as 100:1 to 2:1, such as 75:1 to 3:1, such as 50:1 to 5:1, such as 25:1 to 1:1, such as 25:1 to 2:1, such as 25:1 to 3:1, such as 25:1 to 4.1, such as 25:1 to 5:1, such as 25:1 to 7.5:1, such as 25:1 to 10:1, such as 25:1 to 15:1, such as 20:1 to 1:1, such as 20:1 to 2:1, such as 20:1 to 3:1, such as 20:1 to 4.1, such as 20:1 to 5:1, such as 20:1 to 7.5:1, such as 20:1 to 10:1, such as 20:1 to 15:1, such as 10:1 to 1:1, such as 10:1 to 2:1, such as 10:1 to 3:1, such as 10:1 to 4.1, such as 10:1 to 5:1, such as 10:1 to 7.5:1.

The dispersion may optionally further comprise a carbon nanotube-dispersant adduct comprising the residue of the carbon nanotube and dispersant. For example, the dispersant may comprise a functional group reactive with a functional group present on the carbon nanotube wherein the reactive functional groups may react and form a covalent bond binding the carbon nanotube and dispersant in the adduct. Suitable functional groups present on the carbon nanotube and dispersant are discussed above.

In addition, the carbon nanotube may be functionalized by reaction with melamine to form a melamine-functionalized carbon nanotube. The melamine-functionalized nanotube may then be reacted with a dispersant in order to form the carbon nanotube-dispersant adduct.

As noted above, the dispersion may optionally further comprise a separately added crosslinking agent for reaction with the dispersant. The crosslinking agent should be soluble or dispersible in the organic medium and be reactive with active hydrogen groups of the dispersant, such as the carboxylic acid groups and the hydroxyl groups, if present. Non-limiting examples of suitable crosslinking agents include aminoplast resins, blocked polyisocyanates and polyepoxides.

Examples of aminoplast resins for use as a crossslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

In addition to promoting the cross-linking of the dispersant, the crosslinking agents, including those associated with crosslinking monomers and separately added crosslinking agents, react with the hydrophilic groups, such as active hydrogen functional groups of the dispersant preventing these groups from absorbing moisture that could be problematic in a lithium ion battery.

The separately added crosslinker may be present in the dispersion in amounts of up to 15% by weight, such as 1% to 15% by weight, such as 1% to 10% by weight, such as 1% to 5% by weight, such as 2% to 15% by weight, such as 2% to 10% by weight, such as 2% to 5% by weight, the % by weight being based on the total weight of the binder solids.

The dispersion of the present invention may optionally further comprise an electrically conductive agent other than carbon nanotubes. Non-limiting examples of electrically conductive agents other than carbon nanotubes include carbonaceous materials such as, activated carbon, carbon black such as acetylene black and furnace black, graphite, graphene, carbon fibers, fullerene, carbon nanoribbon (graphene nanoribbon), and combinations thereof.

The weight ratio of the electrically conductive agent (ECA) other than carbon nanotubes to carbon nanotubes may be at least 1,000:1, such as at least 750:1, such as at least 400:1, such as at least 300:1, such as at least 200:1, such as at least 150:1, such as at least 125:1, such as at least 100:1, such as at least 75:1, such as at least 50:1, such as at least 25:1, such as at least 20:1, such as at least 15:1, such as at least 13:1, such as at least 10:1, such as at least 5:1. The weight ratio of the electrically conductive agent other than carbon nanotubes to carbon nanotubes may be no more than 5:1, such as no more than 10:1, such as no more than 15:1, such as no more than 20:1, such as no more than 25:1, such as no more than 50:1, such as no more than 75:1, such as no more than 100:1, such as no more than 125:1, such as no more than 150:1, such as no more than 200:1, such as no more than 300:1, such as no more than 400:1, such as no more than 75:1.

Alternatively, the dispersion may be substantially free, essentially free, or completely free of electrically conductive agents other than carbon nanotubes. A dispersion is “substantially free” of electrically conductive agents other than carbon nanotubes if electrically conductive agents other than carbon nanotubes are present in an amount of less than 1% by weight, based on the total weight of the electrically conductive agent and carbon nanotubes. A dispersion is “essentially free” of electrically conductive agents other than carbon nanotubes if electrically conductive agents other than carbon nanotubes are present in an amount of less than 0.01% by weight, based on the total weight of the electrically conductive agent and carbon nanotubes. A dispersion is “completely free” of electrically conductive agents other than carbon nanotubes if electrically conductive agents other than carbon nanotubes are not present in the dispersion other than as an impurity of the carbon nanotube production, i.e., less than 0.001% by weight.

The electrically conductive agent of the dispersion may comprise, consist essentially of, or consist of carbon nanotubes.

The dispersion may optionally comprise a fluoropolymer. The fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether and any other monomer that would readily copolymerize with vinylidene fluoride in order to produce the fluoropolymer of the present invention. The fluoropolymer may also comprise a PVDF homopolymer.

The fluoropolymer may comprise a high molecular weight PVDF having a weight average molecular weight of at least 50,000 g/mol, such as at least 100,000 g/mol, and may range from 50,000 g/mol to 1,500,000 g/mol, such as 100,000 g/mol to 1,000,000 g/mol. PVDF is commercially available, e.g., from Arkema under the trademark KYNAR from Solvay under the trademark HYLAR, and from Inner Mongolia 3F Wanhao Fluorochemical Co., Ltd.

The fluoropolymer may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 900 nm, such as no more than 600 nm, such as no more than 450 nm, such as no more than 400 nm, such as no more than 300 nm, such as no more than 200 nm. The fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the fluoropolymer particles. The particle size referred to in the present disclosure was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

When fluoropolymer is present, the organic medium optionally may be selected such that the fluoropolymer is dispersed in the organic medium as opposed to being dissolved at room temperature and standard pressure (e.g., about 23° C. and atmospheric pressure of about 1 bar). As the temperature of the composition is increased, the fluoropolymer may dissolve, and the organic medium may optionally have an evaporation rate of less than 10 g/min m², at the dissolution temperature of the fluoropolymer dispersed therein. Evaporation rates may be measured using ASTM D3539 (1996). According to the present invention, the dissolution temperature of the fluoropolymer dispersed in the organic medium may be determined by measuring complex viscosity of the mixture as a function of temperature. This technique may be applied to fluoropolymers (in addition to other types of polymer) mixed in an organic medium where the total mass of non-volatile solids content of such mixtures is from 44% to 46%, such as 45% of the total mass of the mixture. Complex viscosity may be measured with an Anton-Paar MCR301 rheometer using a 50 millimeter cone and temperature-controlled plate. The complex viscosity of fluoropolymer mixtures is measured over a temperature range from 20° C. to at least 75° C. with a temperature ramp rate of 10° C. per minute, an oscillatory frequency of 1 Hz, and a stress amplitude setpoint of 90 Pa. The dissolution of fluoropolymer in the organic medium is indicated by a sharp increase in the complex viscosity as temperature increased. The dissolution temperature is defined as the temperature at which the rate of change in viscosity with increasing temperature is highest and is calculated by determining the temperature at which the first derivative with respect to temperature of the Log₁₀ of the complex viscosity reaches a maximum. The table below illustrates dissolution temperatures determined according to this method using PVDF T-1 from Inner Mongolia 3F Wanhao Fluorochemical Co. Ltd. (PVDF T-1 has a particle size of about 330 to 380 nm and a weight average molecular weight of about 130,000 to 160,000 g/mol), in various solvents or solvent mixtures as listed.

| Solvent | Solvent % mass of organic medium | Cosolvent | Cosolvent % mass of organic medium | PVDF % mass of mixture | Dissolution Temp (°C.) | Evaporation rate at Dissolution Temp (mg/min m²) |
|---|---|---|---|---|---|---|
| N-butylpyrrolidone | 100 | – | – | 45 | 48 | – |
| gamma-butyrolactone | 100 | – | – | 45 | 51 | 9.31 |
| Isophorone | 100 | – | – | 45 | 72 | 16.59 |
| Triacetin | 100 | – | – | 45 | 76 | 0.69 |
| Ethyl Acetoacetate | 100 | – | – | 45 | 76 | 37.76 |
| Triethylphosphate | 80 | Ethyl Acetoacetate | 20 | 45 | 46 | – |
| Triethylphosphate | 80 | Dowanol™ PM¹ | 20 | 45 | 58 | – |

¹ Propylene glycol methyl ether commercially available from The Dow Chemical Company.

The dissolution temperature of the fluoropolymer dispersed in the organic medium may be less than 77° C., such as less than 70° C., such as less than 65° C., such as less than 60° C., such as less than 55° C., such as less than 50° C. The dissolution temperature of the fluoropolymer dispersed in the organic medium may range from 30° C. to 77° C., such as from 30° C. to 70° C., such as 30° C. to 65° C., such as 30° C. to 60° C., such as 30° C. to 55° C., such as 30° C. to 50° C. The dissolution temperature may be measured according to the method discussed above.

The dispersant optionally may also serve to assist in dispersing the fluoropolymer if present. In such cases, the dispersant will have at least one phase that is compatible with the fluoropolymer.

The fluoropolymer may be solubilized in the organic medium.

The dispersion may be substantially free, essentially free, or completely free of dispersed fluoropolymer. As used herein, the dispersion is “substantially free” of dispersed fluoropolymer if dispersed fluoropolymer is present, if at all, in an amount of less than 0.5% by weight, based on the total weight of the dispersion. As used herein, the dispersion is “essentially free” of dispersed fluoropolymer if dispersed fluoropolymer is present, if at all, in an amount of less than 0.1% by weight, based on the total weight of the dispersion. As used herein, the dispersion is “completely free” of dispersed fluoropolymer if dispersed fluoropolymer is not present in the dispersion, i.e., 0.00% by weight, based on the total weight of the dispersion.

The dispersion may be substantially free, essentially free, or completely free of fluoropolymer. As used herein, the dispersion is “substantially free” of fluoropolymer if fluoropolymer is present, if at all, in an amount of less than 0.5% by weight, based on the total weight of the dispersion. As used herein, the dispersion is “essentially free” of fluoropolymer if fluoropolymer is present, if at all, in an amount of less than 0.1% by weight, based on the total weight of the dispersion. As used herein, the dispersion is “completely free” of fluoropolymer if fluoropolymer is not present in the dispersion, i.e., 0.00% by weight, based on the total weight of the dispersion.

The dispersion may comprise, consist essentially of, or consist of an organic medium, carbon nanotubes dispersed in the organic medium, and a dispersant.

The dispersion may comprise, consist essentially of, or consist of an organic medium comprising, consisting essentially of, or consisting of a trialkyl phosphate, carbon nanotubes dispersed in the organic medium, and a dispersant.

The dispersion may comprise, consist essentially of, or consist of an organic medium comprising, consisting essentially of, or consisting of a trialkyl phosphate and ethyl acetoacetate, carbon nanotubes dispersed in the organic medium, and a dispersant.

As mentioned above, the present invention is also directed to a slurry composition for producing a battery electrode comprising the dispersion as discussed above, an electrochemically active material, and a binder.

The slurry composition may comprise an electrochemically active material. The material constituting the electrochemically active material contained in the slurry is not particularly limited and a suitable material can be selected according to the type of an electrical storage device of interest.

The electrochemically active material may comprise a material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, aluminum, tin, SnCo, Fe₃O₄, and combinations thereof.

The electrochemically active material may comprise a material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 85% to 99% by weight, such as 95% to 99% by weight, such as 97% to 99% by weight, such as 98% to 99% by weight, such as 55 to 98% by weight, such as 65% to 98% by weight, such as 70% to 98% by weight, such as 80% to 98% by weight, such as 90% to 98% by weight, such as 91% to 98% by weight, such as 91% to 95% by weight, such as 94% to 98% by weight, such as 95% to 98% by weight, such as 96% to 98% by weight, such as 94% to 99%, such as 95% to 99%, such as 96% to 99%, such as 97% to 99% based on the total solids weight of the slurry.

The binder may comprise the fluoropolymer, dispersant, and separately added crosslinking agent, each of which was described above.

The fluoropolymer may be present in in the binder in amounts of 40% to 100% by weight, such as 40% to 96% by weight, such as 50% to 95% by weight, such as 50% to 90% by weight, such as 70% to 90% by weight, such as 80% to 90% by weight, based on the total weight of the binder solids.

The dispersant may be present in the slurry composition in an amount of 0.1% to 10% by weight, such as 1% to 6% by weight, such as 1.3% to 4.5% by weight, such as 1.9% to 2.9% by weight, based on the total solids weight of the slurry composition.

The separately added crosslinking agent may be present in the slurry composition in an amount of 0.001% to 5% by weight, such as 0.002% to 2% by weight, such as 0.002 to 1% by weight, such as 0.005 to 0.5% by weight, such as 0.005 to 0.3% by weight, such as 0.1% to 5% by weight, based on the total solids weight of the slurry composition.

As used herein, the term “resin solids” may be used synonymously with “binder solids” and include the fluoropolymer and, if present, the dispersant, and separately added crosslinking agent. As used herein, the term “binder dispersion” refers to a dispersion of the binder solids in the organic medium.

The fluoropolymer may be present in the binder in amounts of 40% to 96% by weight, such as 50% to 90% by weight; the dispersant may be present in amounts of 2% to 20% by weight, such as 5% to 15% by weight; the adhesion promoter may be present in the slurry composition in an amount of 10% to 60% by weight, 20% to 60% by weight, such as 30% to 60% by weight, such as 10% to 50% by weight, such as 15% to 40% by weight, such as 20% to 30% by weight, such as 35% to 35% by weight; and the separately added crosslinker may be present in amounts of up to 15% by weight, such as 1% to 15% by weight, the % by weight being based on the total weight of the binder solids. The organic medium is present in the binder dispersion in amounts of 20% to 70% by weight, such as 30% to 60% by weight, based on total weight of the binder dispersion.

The binder solids may be present in the slurry in amounts of 1% to 20% by weight, such as 1% to 10% by weight, such as 5% to 10% percent by weight, based on the total solids weight of the slurry.

The slurry composition of the present invention may optionally further comprise an electrically conductive agent other than carbon nanotubes. Non-limiting examples of electrically conductive agents include carbonaceous materials such as, activated carbon, carbon black such as acetylene black and furnace black, graphite, graphene, carbon fibers, fullerene, carbon nanoribbon (graphene nanoribbon), and combinations thereof. The electrically conductive material may also comprise any active carbon that has a high-surface area, such as a BET surface area of greater than 100 m²/g. In some examples, the conductive carbon can have a BET surface area of 100 m²/g to 1,000 m²/g, such as 150 m²/g to 600 m²/g, such as 100 m²/g to 400 m²/g, such as 200 m²/g to 400 m²/g. In some examples, the conductive carbon can have a BET surface area of about 200 m²/g. A suitable conductive carbon material is LITX 200 commercially available from Cabot Corporation. As stated above, graphene can be used as the electrically conductive agent. Typical BET surface areas for graphene range from 300 to 1600 m²/g. In some instances, the measured surface area of graphene may exceed 2000 m²/g.

The electrically conductive agent, including the carbon nanotubes, may be present in the slurry in amounts of 1% to 20% by weight, such as 1% to 15% by weight, such as 1% to 10% by weight, such as 1% to 5% by weight, such as 1% to 4% by weight, such as 1% to 3% by weight, such as 1% to 2% by weight, such as 2% to 20% by weight, such as 2% to 10% by weight, such as 2% to 8% by weight, such as 2% to 6% by weight, such as 2.5% to 5% by weight, such as 5% to 10% by weight, based on the total solids weight of the slurry.

Carbon nanotubes may be present in the slurry composition in an amount of at least 0.001% by weight, such as at least 0.0025% by weight, such at least 0.005% by weight, such as at least 0.0075% by weight, such as at least 0.01% by weight, such as 0.025% by weight, such as 0.05% by weight, such as at least 0.075% by weight, such as at least 0.1% by weight, such as at least 0.25% by weight, such as at least 0.5% by weight, such as at least 0.75% by weight, such as at least 1% by weight, such as at least 2% by weight, based on the total solids weight of the slurry composition. Carbon nanotubes may be present in the slurry composition in an amount of no more than 2% by weight, such as no more than 1% by weight, such as no more than 0.5% by weight, based on the total solids weight of the slurry composition. Carbon nanotubes may be present in the slurry composition in an amount of 0.001% to 2% by weight, such as 0.0025% to 2% by weight, such as 0.005% to 2% by weight, such as 0.075% to 2% by weight, such as 0.01% to 1% by weight, such as 0.025% to 1% by weight, such as 0.05% to 1% by weight, such as 0.075% to 1% by weight, such as 0.1% to 1% by weight, such as 0.1% to 2% by weight, such as 0.25% to 1% by weight, such as 0.25% to 2% by weight, such as 0.5% to 1% by weight, such as 0.5% to 2% by weight, such as 0.75% to 1% by weight, such as 0.75% to 2% by weight, such as 0.025% to 0.5% by weight, such as 0.05% to 0.5% by weight, such as 0.075% to 0.5% by weight, such as 0.1% to 0.5% by weight, based on the total solids weight of the slurry composition.

The electrode slurry composition comprising the organic medium, electrochemically active material, carbon nanotubes, optional electrically conductive material other than carbon nanotubes, binder, additional organic medium, if needed, and optional ingredients, may be prepared by combining the ingredients to form the slurry. These substances can be mixed together by agitation with a known means such as a stirrer, bead mill or highpressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The slurry composition may have a solids content of at least 30% by weight, such as at least 40% by weight, such as at least 50% by weight, such as at least 55%, such as at least 60%, such as at least 65%, such as at least 71%, such as at least 75%, and may be no more than 90% by weight, such as no more than 85% by weight, such as no more than 75% by weight, the % by weight based on the total weight of the slurry composition. The slurry composition may have a solids content of 30% to 90% by weight, such as 40% to 85% by weight, such as 50% to 85% by weight, such as 55% to 85% by weight, such as 60% to 85% by weight, such as 65% to 85% by weight, such as 71% to 85% by weight, such as 75% to 85% by weight, based on the total weight of the slurry composition.

The present invention is also directed to an electrode comprising an electrical current collector and a film formed on the electrical current collector, wherein the film is deposited from the electrode slurry composition described above. The electrode may be a positive electrode or a negative electrode and may be manufactured by applying the above-described slurry composition to the surface of the current collector to form a coating film, and subsequently drying and/or curing the coating film. The coating film may have a thickness of at least 1 micron, such as 1 to 500 microns (µm), such as 1 to 150 µm, such as 25 to 150 µm, such as 30 to 125 µm. The coating film may comprise a cross-linked coating. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the organic medium is removed may be 25 to 150 microns (µm), such as 30 to 125 µm.

Drying and/or crosslinking the coating film after application, if applicable, can be done, for example, by heating at elevated temperature, such as at least 50° C., such as at least 60° C., such as 50-145° C., such as 60-120° C., such as 65-110° C. The time of heating will depend somewhat on the temperature. Generally, higher temperatures require less time for curing. Typically, curing times are for at least 5 minutes, such as 5 to 60 minutes. The temperature and time should be sufficient such that the dispersant in the cured film is crosslinked (if applicable), that is, covalent bonds are formed between co-reactive groups on the dispersant polymer chain, such as carboxylic acid groups and hydroxyl groups and the N-methylol and/or the N-methylol ether groups of an aminoplast, isocyanato groups of a blocked polyisocyanate crosslinking agent, or in the case of a self-curing dispersant, the N-alkoxymethyl amide groups or blocked isocyanato groups. The extent of cure or crosslinking may be measured as resistance to solvents such as methyl ethyl ketone (MEK). The test is performed as described in ASTM D-540293. The number of double rubs, one back and forth motion, is reported. This test is often referred to as “MEK Resistance”. Accordingly, the dispersant and crosslinking agent (inclusive of self-curing dispersants and dispersants with separately added crosslinking agents) is isolated from the binder composition, deposited as a film and heated for the temperature and time that the binder film is heated. The film is then measured for MEK Resistance with the number of double rubs reported. Accordingly, a crosslinked dispersant will have an MEK Resistance of at least 50 double rubs, such as at least 75 double rubs. Also, the crosslinked dispersant may be substantially solvent resistant to the solvents of the electrolyte mentioned below. Other methods of drying the coating film include ambient temperature drying, microwave drying and infrared drying, and other methods of curing the coating film include e-beam curing and UV curing.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present invention is also directed to an electrical storage device. An electrical storage device according to the present invention can be manufactured by using the above electrodes prepared from the slurry composition of the present invention. The electrical storage device comprises an electrode, a counter electrode and an electrolyte. The electrode, counterelectrode or both may comprise the electrode of the present invention, as long as one electrode is a positive electrode and one electrode is a negative electrode. Electrical storage devices according to the present invention include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB ₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

The dispersion may be substantially free, essentially free, or completely free of N-Methyl-2-pyrrolidone (NMP). As used herein, the dispersion is “substantially free” of NMP if NMP is present, if at all, in an amount of less than 5% by weight, based on the total weight of the dispersion. As used herein, the dispersion is “essentially free” of NMP if NMP is present, if at all, in an amount of less than 0.3% by weight, based on the total weight of the dispersion. As used herein, the dispersion is “completely free” of NMP if NMP is not present in the dispersion, i.e., 0.0% by weight, based on the total weight of the dispersion.

The dispersion may be substantially free, essentially free, or completely free of ketones such as methyl ethyl ketone, cyclohexanone, isophorone, acetophenone.

The dispersion may be substantially free, essentially free, or completely free of ethers such as the C₁ to C₄ alkyl ethers of ethylene or propylene glycol.

The dispersion may be substantially free, essentially free, or completely free of polyvinyl alcohol or modified polyvinyl alcohol.

The dispersion may be substantially free, essentially free, or completely free of an alkyl ammonium salt copolymer.

The dispersion may be substantially free, essentially free, or completely free of an olefin block maleic anhydride copolymer.

The dispersion may be substantially free, essentially free, or completely free of a vinyl pyrrolidone copolymer.

The dispersion may be substantially free, essentially free, or completely free of polyvinyl pyrrolidone.

The dispersion may be substantially free, essentially free, or completely free of activated carbon.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography (GPC) using Waters 2695 separation module with a Waters 410 differential refractometer (RI detector), linear polystyrene standards having molecular weights of from 580 Da to 365,000 Da, dimethylformamide (DMF) with 0.05 M lithium bromide (LiBr) as the eluent at a flow rate of 0.5 mL/min, and one Shodex Asahipak GF-510 HQ column (300 × 7.5 mm, 5 µm) for separation.

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the dispersion or slurry composition.

As used herein, unless otherwise defined, the term essentially free means that the component is present, if at all, in an amount of less than 1% by weight, based on the total weight of the dispersion or slurry composition.

As used herein, unless otherwise defined, the term completely free means that the component is not present in the slurry composition, i.e., 0.00% by weight, based on the total weight of the dispersion or slurry composition.

As used herein, the term “total solids” refers to the non-volatile components of the dispersion or slurry composition of the present invention and specifically excludes the organic medium.

As used herein, the term “consists essentially of” includes the recited material or steps and those that do not materially affect the basic and novel characteristics of the claimed invention.

As used herein, the term “consists of” excludes any element, step or ingredient not recited.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “a” dispersant, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the invention have been described in terms of “comprising”, embodiments consisting essentially of or consisting of are also within the scope of the present invention.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the slurry composition and the substrate.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

Chemical suppliers: All acrylic monomers are available from BASF or Dow Chemical Company. Trigonox is available from AkzoNobel. PVDF was obtained from Shanghai 3F (T-1 PVDF, “PVDF 1”) and Solvay (PVDF Solef 5130, “PVDF 2”). Triethylphosphate (“TEP”) and ethyl acetoacetate (“EAA”) are both available from the Eastman Chemical Company. Conductive carbon LITX 200 was obtained from Cabot. NMC622 is also available from Targray. Resimene HM-2608 (90% active material in isobutanol) was obtained from INEOS. A 10% active material solution of Resimene HM-2608 was prepared in TEP (“additive solution Z”). Carbon nanotubes were obtained in dry powder form. and Tuball (CNT-2). Miralon pulp (“CNT-1”) is a multi-walled carbon nanotube available from Huntsman (formerly available from Nanocomp Technologies as carbon nanotube pulp) has a BET surface area of 200 m²/g and TUBALL (“CNT-2”) is a single-walled carbon nanotube available from OCSiAl with a width of 1.6±0.4 nm, a length of greater than 5 microns, and BET surface area of greater than 300 m²/g.

### Synthesis of Acrylic Resin Dispersants

The following table contains abbreviations or trade names of solvents, radical initiators, or acrylic monomer used in the examples:

| | | |
|---|---|---|
| Abbreviation or Trade Name | Role | Chemical Name |
| TEP | Solvent | Triethyl phosphate |
| Trigonox 131 | Radical initiator | tert-Amylperoxy 2-ethylhexyl carbonate |
| NVP | Monomer | N-Vinyl pyrrolidone |
| MMA | Monomer | Methyl methacrylate |
| EHA | Monomer | 2-Ethylhexyl acrylate |
| EA | Monomer | Ethyl acrylate |
| HEA | Monomer | 2-Hydroxyethyl acrylate |
| MAA | Monomer | Methacrylic acid |
| GMA | Monomer | Glycidyl methacrylate |

General synthesis procedure: Acrylic resin dispersants were prepared using the monomer compositions provided in the table below according to the following procedure: In a four neck round bottom flask, triethyl phosphate (TEP, addition 1) was added and the flask was set up with a mechanical stir blade, thermocouple, and reflux condenser. The flask containing TEP solvent was heated to a set point of 120° C. under a nitrogen atmosphere. A monomer solution was prepared using thorough mixing in a separate container. A solution of Trigonox 131 in TEP (addition 2) was prepared and added into the flask via an addition funnel over 360 minutes. Five minutes after the initiator solution started, the monomer solution was added into the flask via a second addition funnel over 300 minutes. After the monomer feed was complete, the monomer addition funnel was rinsed TEP (Rinse 1). After the initiator feed was complete, the initiator addition funnel was rinsed with TEP (Rinse 2). The reaction was then held at 120° C. for 60 minutes. After the 60 minute hold, the reaction was cooled and poured into a suitable container. The solids content of the acrylic resin dispersant compositions was measured in each composition example by the following procedure: An aluminum weighing dish from Fisher Scientific, was weighed using an analytical balance. The weight of the empty dish was recorded to four decimal places. Approximately 0.5 g of dispersant was added to the weighed dish and the weight of the dish, and the acrylic resin solution was recorded to four decimal places. Next approximately 3.5 g of acetone was added to the weighing dish. The dish containing the acrylic resin solution and acetone was placed into a laboratory oven, with the oven temperature set to 110° C., and dried for 1 hour. The dish and dried acrylic resin were weighed using an analytical balance. The weight of the dish and dried acrylic resin was recorded to four decimal places. The solids content was determined using the following equation: % solids = 100 × [(weight of the dish and the dry acrylic resin)-(weight of the empty dish)] / [(weight of the dish and the acrylic resin solution)-(weight of the empty dish)]. The weight % solids of Resin A, B, C, and D were all 51%.

TABLE 1

Chemicals used in synthesis of acrylic resin dispersants

| Material (amounts in parts by weight) | Resin A | Resin B | Resin C | Resin D |
|---|---|---|---|---|
| TEP Addition 1 | 32.8 | 32.8 | 32.6 | 32.8 |
| MMA | 19.9 | 19.9 | 19.8 | 19.9 |
| EHA | 15.3 | 18.8 | 16.8 | 21.4 |
| EA | 13.7 | 5.1 | 7.9 | 0.0 |
| NVP | 0.0 | 5.1 | 0.0 | 7.6 |
| HEA | 1.0 | 1.0 | 1.0 | 1.0 |
| MAA | 1.0 | 1.0 | 0.0 | 1.0 |
| GMA | 0.0 | 0.0 | 5.1 | 0.0 |
| Trigonox | 1.0 | 1.0 | 1.2 | 1.0 |
| TEP Addition 2 | 14.0 | 14.0 | 14.1 | 14.0 |
| TEP Rinse 1 | 1.3 | 1.3 | 1.2 | 1.3 |
| TEP Rinse 2 | 1.3 | 1.3 | 1.2 | 1.3 |

### Example 1: Preparation of Binder Compositions and CNT-1 Dispersions

Comparative Binder Composition 1: An 8% solution of PVDF-2 was prepared in NMP in a glass jar under nitrogen blanket. The solution was stirred and heated at 120° C. for three hours to ensure dissolution. This material was used as the comparative binder.

Binder Composition 2: Binder Composition 2 was prepared in a mixture of TEP and EAA with the addition of resin A, resin B, resin C, PVDF 1, and PVDF 2 in the following weight proportions: 1.75 parts acrylic resin dispersants, 5.48 parts PVDF, 44.94 parts TEP, and 1.0 part EAA. The weight ratio of acrylic resin A to resin B to resin C was 2.0 to 1.0 to 1.2 and the weight ratio of PVDF-1 to PVDF-2 was 1.86 to 1.00. Binder Composition 2 was prepared in two separate operations. First, resin C was added to 41.1 parts TEP under high shear mixing. To this mixture was added PVDF 2. The second step involved the addition of 3.54 parts TEP and 1.0 part EAA under high shear mixing. To the TEP/EAA mixture was added resin A and resin B followed by PVDF 1. Finally, both mixtures were combined resulting in Binder Composition 2. Binder Composition 2 had a total solids (by weight) of 12.0%.

Binder Composition 3: An 8.5% solids solution of PVDF-2 and resin B was prepared in a nitrogen filled glovebag. All of the materials were added to a large glass jar with a lid and stirred at ambient temperature until dissolution occurred. The ratio of materials used to make Binder Composition 3 was 38.7 parts TEP, 3.14 parts PVDF-2, and 1.0 parts Resin B.

Binder Composition 4: Binder composition 4 was prepared in the same manner as Binder Composition 3 except that Resin D was substituted for Resin B. The ratio of materials used to make Binder Composition 4 was 38.7 parts TEP, 3.14 parts PVDF-2, and 1.0 parts Resin D.

Preparation of CNT-1 dispersions: Dispersions of CNT-1 were prepared using the components of Table 2 below and the following general procedure which combined an asymmetric centrifugal high speed mixer (Flack Tek, INC. speed mixer DAC400.1 FVZ) and high shear three-roll mill mixer (Keith Machinery Corp, Anthony 2.5″ × 5″, Serial number -30984). Dispersions were prepared on a 100-g scale. To a container was added solvent, Binder Composition (PVDF and dispersant), and CNT-1. A step mixing procedure (800 rpm for 30 seconds, 2000 rpm for 30 seconds and 2750 rpm for 30 seconds) was developed for high speed asymmetric centrifugal mixer. This mixing procedure is repeated three times with a 10 min interval in every mix to maintain the temperature below 35° C. The temperature was measured by IR-thermal probe meter. After high speed mixing, the CNT-1 dispersion is mixed with high shear rate three-roll mixer at 25 rpm. The centrifugal mixing procedure was repeated to ensure uniformity of the CNT-1 dispersion.

TABLE 2

CNT-1 Dispersion Solvents and Binders

| | | |
|---|---|---|
| CNT Dispersion | Solvent | Binder |
| Comparative | NMP | Comp. Composition 1 |
| Inventive 1 | TEP/EAA | Composition 2 |
| Inventive 2 | TEP | Composition 3 |
| Inventive 3 | TEP | Composition 4 |

CNT Dispersion Comparative: This dispersion was prepared by combining CNT-1, Comparative Binder Composition 1, and NMP according to the procedure above. The final dispersion was 1.5 wt.% CNT-1 and had a total solids of 8.6% based on the total composition.

CNT Dispersion Inventive 1: This dispersion was prepared by combining CNT-1, Binder Composition 2, and TEP according to the procedure above. The final dispersion was 1.5 wt.% CNT-1 and had a total solids of 12.5% based on the total composition.

CNT Dispersion Inventive 2: This dispersion was prepared by combining CNT-1, Binder Composition 3, and TEP according to the procedure above. The final dispersion was 1.5 wt.% CNT-1 and had a total solids of 8.6% based on the total composition.

CNT Dispersion Inventive 3: This dispersion was prepared by combining CNT-1, Binder Composition 4, and TEP according to the procedure above. The final dispersion was 1.5 wt.% CNT-1 and had a total solids of 8.6% based on the total composition.

### Analysis and Characterizations of CNT-1 Dispersions

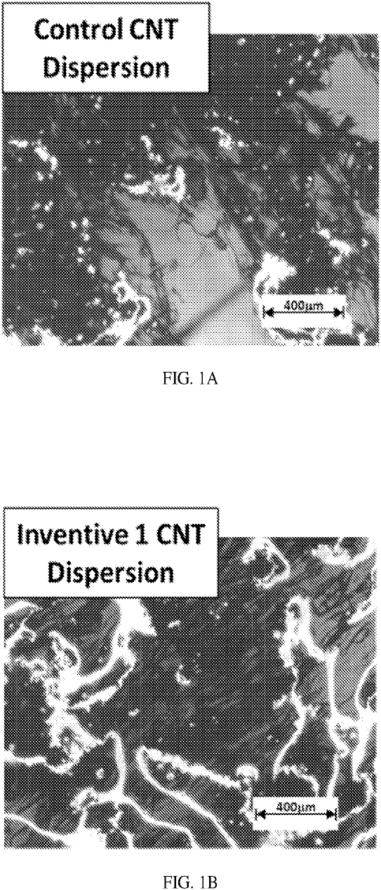

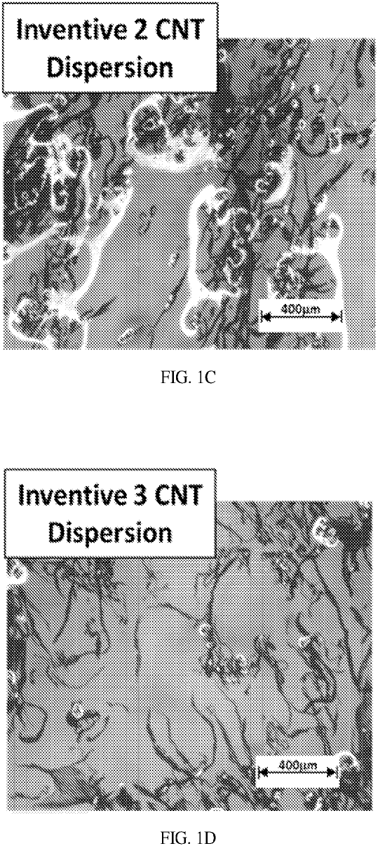

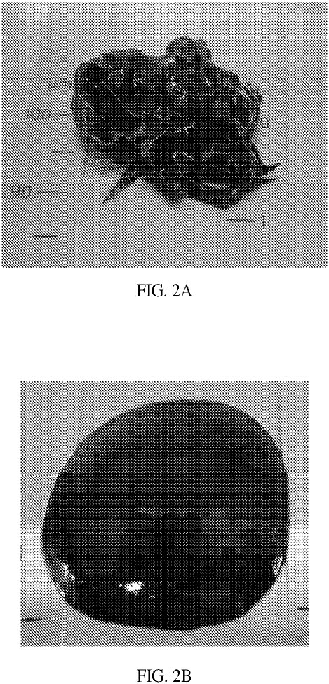

The quality of dispersion is examined by optical microscope (Keyence, One-Shot 3D Measuring Microscope, and Model No. VR3200). A good dispersion has flat, open sheetlets and elongated CNTs, whereas a poor dispersion shows a spiral, branched and agglomerated CNTs. Comparing the micrographs as shown in FIG. 1A, FIG. 1B, FIG. 1C, and FIG. 1D, inventive dispersion compositions (FIGS. 1B, 1C, and 1D) show better dispersion (CNTs flattened instead of curling) quality as compared to control dispersant (FIG. 1A). FIG. 2A and FIG. 2B also show a comparison of Comparative CNT-1 Dispersion (FIG. 2A) and Inventive 1 CNT-1 Dispersion (FIG. 2B) that show the Inventive CNT-1 Dispersion has a more uniform appearance, better fluid properties, and is more easily cast into a film (using a doctor blade whereas the Comparative CNT-1 Dispersion appears to be somewhat shriveled.

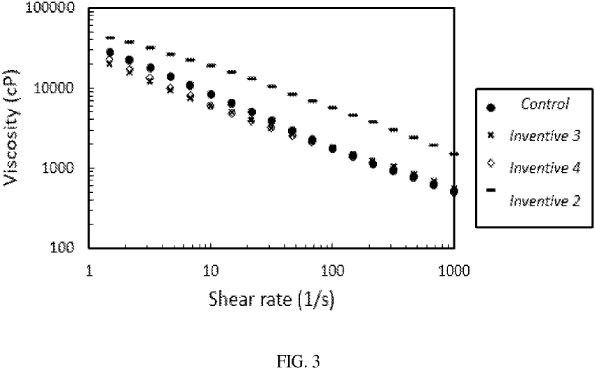

The viscosity of the CNT dispersions was analyzed by a Rheometer (Anton Paar, MCR 301, Serial Number - 80689782). As shown in FIG. 3, CNT dispersion with inventive binder compositions 3 and 4 had a reduced viscosity at the same solid levels as the control CNT dispersion.

Accordingly, based upon these experimental results, the acrylic resin dispersants and binder compositions that include the same improved the dispersion quality of CNT-1 compared to the standard PVDF-NMP system.

### Example 2: Preparation of Positive Electrode Slurries Using CNT-2

General procedure for making positive electrode slurries (comparative slurry S5 and inventive slurry S6): In a nitrogen filled glove bag, the binder solution was diluted with a mixture of TEP/EAA and added to a Thinky cup. Next conductive carbon (and CNT-2, if applicable) was added and mixed with a wooden blade by hand. The Thinky cup was capped and removed from the glove bag. Dispersion of the carbon was achieved using a centrifugal mixer. Once homogenous, the carbon slurry was returned to the glove bag, uncapped, and the active material was added. The active material/carbon slurry was mixed by hand using a wooden blade, capped, and removed from the glove bag. Dispersion of the active material was achieved using a centrifugal mixer. Once homogenous, the carbon/active material slurry was returned to the glove bag, uncapped, and the additive solution was added. The fully formulated cathode slurry was mixed by hand using a wooden blade, capped, and removed from the glove bag. Final dispersion of all of the cathode slurry components was completed using a centrifugal mixer.

Preparation of comparative positive electrode slurry that does not contain CNT -slurry S5: This slurry was prepared on 98-gram scale with a weight ratio of 96% active material to 2% conductive carbon to 2% binder. Table 3 provides the exact weights of the components used in the preparation of slurry S5 according to method 1. The weight% solids of the slurry was 73%.

TABLE 3

Cathode Slurry S5 components

| | | Slurry S5 |
|---|---|---|
| Component | Role | Amount (grams) |
| NCM622 | Active Material | 68.160 |
| Litx 200 | Conductive Carbon | 1.42 |
| CNT-2 | Carbon nanotube | – |
| Binder Composition 2 | Binder | 11.83 |
| TEP | Diluent | 15.47 |
| EAA | Diluent | 1.12 |
| Additive Solution Z | Additive | 0.21 |

Preparation of inventive CNT-containing positive electrode slurry - slurry S6: This slurry was prepared on 104-gram scale with a weight ratio of 96% active material to 1.9% conductive carbon to 0.1% CNT-2 to 2% binder. Table 4 provides the exact weights of the components used in the preparation of slurry S6 according to method 1. The weight% solids of the slurry was 67%.

TABLE 4

Cathode Slurry S6 components

| | | Slurry S6 |
|---|---|---|
| Component | Role | Amount (grams) |
| NCM622 | Active Material | 68.160 |
| Litx 200 | Conductive Carbon | 1.349 |
| CNT-2 | Carbon nanotube | 0.071 |
| Binder Composition 2 | Binder | 11.83 |
| TEP | Diluent | 21.17 |
| EAA | Diluent | 1.42 |
| Additive Solution Z | Additive | 0.21 |

### Evaluation of CNT-2 Impact on Viscosity of Cathode Slurry

The rheology of slurry S5 and S6 were collected in the manner described above. The results are shown in Table 5 with the addition of CNT-2 significantly increasing the viscosity of the slurry.

TABLE 5

Rheology measurements of cathode slurries S5 and S6

| Slurry | CNT | Viscosity (cP) | | | | |
|---|---|---|---|---|---|---|
| | | Shear Rate 1/s | Shear Rate 10/s | Shear Rate 50/s | Shear Rate 100/s | Shear Rate 1000/s |
| S5 | None | 3187 | 2530 | 1365 | 1110 | 740 |
| S6 | CNT-2 | 83256 | 16108 | 5417 | 3386 | 1233 |

Preparation of Positive Electrode Films from Slurries S5 and S6: Electrode films cast from slurry S5 and slurry S6 were prepared using a 3-5 mil draw down bar on a draw down table onto aluminum foil. The deposited films were cured in electric ovens at 55° C. and 120° C. for 2 minutes in each oven in sequence. The film was pressed using a calendar press to a porosity of 35% and the films had a dry film thickness within 95-105 microns. The coating density of the film was about 25 mg/cm² for both electrodes cast from S5 and S6.

Characterization of Positive Electrode Films from Slurries S5 and S6: The cured, pressed positive electrode films cast from slurries S5 and S6 were evaluated for adhesion and electrical resistivity. The results of these analysis are in Table 6 and the method of data collection is described in the following paragraphs.

Strips of coated electrode were cut 0.5 inches and affixed to an electrocoated steel panel using 3M 444 double sided tape. The adhesive strength of two strips of coated electrode were evaluated for both S5 and S6 produce positive electrodes using a 90-degree peel test on MARK-10 ESM303 at a speed of 50 mm/min. This test is referred to herein as the PEEL STRENGTH TEST.

Resistivity of these positive electrode coatings with and without CNT were measured by using HIOKI electrode resistance meter (HIOKI RM26111). The resistivity data was collected at three different areas of electrodes and used the average value for accuracy. Cathode bulk resistivity indicates the barrier of charge transport in the coating. Higher resistivity means poor conductivity and thus sluggish charge transport and vice versa for lower resistivity. A better charge transport in electrode coatings (lower resistivity) enables power performance (fast charge-discharge) of a battery.

TABLE 6

Characterization of electrode coatings from S5 and S6

| Positive Electrode Film Cast from Slurry | CNT | Peel Strength (N/m) | Volume Resistivity (Ω·cm) |
|---|---|---|---|
| S5 | None | 18 | 14.3 |
| S6 | CNT-2 | 28 | 1.3 |

Rate Capability of Positive Electrode Films from Slurries S5 and S6: Electrodes were tested in half cell coin cells. The prepared electrodes were cut into a disk with 10 mm in diameter. Lithium metal was used as the counter electrode and the electrolyte was 75 µL 1.0 M LiPF₆ in EC/EMC (3:7, v:v). Battery cells were evaluated by Bio-Logic BCS-805 tester. The cells were tested at C/10 for 4 cycles, C/3 for 10 cycles, 1C for 5 cycles, and 2C for 4 cycles. As shown in Table 7 below, the only significant difference between rate capability occurs at 2C, where the addition of CNT-2 (in electrode S6) has better performance.

TABLE 7

Characterization of electrode coatings from S5 and S6

| Film Cast from Slurry | CNT | Initial Capacity (mAh/g) | C/10 Capacity (mAh/g) | C/3 Capacity (mAh/g) | 1C Capacity (mAh/g) | 2C Capacity (mAh/g) |
|---|---|---|---|---|---|---|
| S5 | None | 158 | 158 | 154 | 143 | 71 |
| S6 | CNT-2 | 158 | 158 | 153 | 146 | 91 |

These results demonstrate that the addition of CNT to the positive electrode slurry composition improves both the adhesion and reduces the volume resistivity. Better performance in both adhesion and lower electrical resistance will often translate into improved battery performance. This is, indeed, the case when using the CNT with conductive carbon versus just carbon as the conductive additive.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

What is claimed is:

1. A dispersion of carbon nanotubes comprising:
an organic medium,
carbon nanotubes dispersed in the organic medium, and
a dispersant comprising an addition polymer comprising constitutional units comprising the residue of an alkyl ester of (meth)acrylic acid containing from 1 to 3 carbon atoms in the alkyl group in an amount of 20% to 98% by weight, based on the total weight of the addition polymer.

2. The dispersion of claim 1, wherein the carbon nanotubes comprise single-wall carbon nanotubes.

3. The dispersion of claim 1, wherein the carbon nanotubes comprise multi-wall carbon nanotubes.

4-5. (canceled)

6. The dispersion of claim 1, wherein the carbon nanotubes are substituted with functional groups comprising carbonyl, hydroxyl, amine, and/or amide functional groups.

7-18. (canceled)

19. The dispersion of claim 1, wherein the carbon nanotubes are present in the dispersion in an amount of 0.1% to 10% by weight, based on the total solids weight of the dispersion.

20. (canceled)

21. The dispersion of claim 1, wherein the organic medium comprises, trialkyl phosphate, and the trialkyl phosphate comprises trimethylphosphate, triethylphosphate, tripropylphosphate, tributylphosphate, or a combination thereof.

22. (canceled)

23. The dispersion of claim 1, wherein the organic medium comprises, triethyl phosphate and ethyl acetoacetate.

24. The dispersion of claim 1, wherein the organic medium comprises a primary solvent and a co-solvent that form a homogenous continuous phase with the carbon nanotubes as the dispersed phase.

25-29. (canceled)

30. The dispersion of claim 1, wherein the dispersant comprises a reactive group and a tail group, wherein the reactive group comprises silanes, carboxylic acids, phosphonic acids, quaternary ammonium ion, groups capable of hydrogen bonding such an oxygen, nitrogen, or fluorine-containing groups (e.g., hydroxyl, amine, etc.), or salts thereof, and the tail group comprises a second functionality that helps to prevent the interaction of carbon nanotubes with each other.

31. (canceled)

32. The dispersion of claim 1, wherein the dispersant comprises functional groups, wherein the functional groups comprise hydroxyl groups, primary or secondary amino groups, amide groups, carboxylic acid groups, thiol groups, lactams, lactones, epoxides, or any combination thereof.

33-36. (canceled)

37. The dispersion of claim 1, wherein the addition polymer further comprises constitutional units comprising the residue of an alpha, beta-ethylenically unsaturated carboxylic acid, wherein constitutional units comprising the residue of the alpha, beta-ethylenically unsaturated carboxylic acids may comprise 1% to 50% by weight, based on the total weight of the addition polymer.

38-40. (canceled)

41. The dispersion of claim 1, wherein the addition polymer further comprises constitutional units comprising the residue of an alkyl esters of (meth)acrylic acid containing from 4 to 7 carbon atoms in the alkyl group, wherein constitutional units comprising the residue of the alkyl esters of (meth)acrylic acid containing from 4 to 7 carbon atoms in the alkyl group comprise 2% to 70% by weight, based on the total weight of the addition polymer.

42-43. (canceled)

44. The dispersion of claim 1, wherein the addition polymer further comprises constitutional units comprising the residue of an alkyl esters of (meth)acrylic acid containing from 8 to 22 carbon atoms in the alkyl group, wherein constitutional units comprising the residue of the alkyl esters of (meth)acrylic acid containing from 8 to 22 carbon atoms in the alkyl group comprise 2% to 70% by weight, based on the total weight of the addition polymer, or
wherein the addition polymer further comprises constitutional units comprising the residue of an ethylenically unsaturated monomer comprising a heterocyclic group, wherein constitutional units comprising the residue of the ethylenically unsaturated monomers comprising a heterocyclic group may comprise 0.5% to 99% by weight, based on the total weight of the addition polymer, or
wherein the addition polymer comprises constitutional units comprising the residue of a self-crosslinking monomer, and the addition polymer comprises a self-crosslinking addition polymer, wherein constitutional units comprising the residue of the self-crosslinking monomer may comprise 0.5% to 30% by weight, based on the total weight of the addition polymer.

45-47. (canceled)

48. The dispersion of claim 1, wherein the addition polymer further comprises constitutional units comprising the residue of a hydroxyalkyl ester, wherein constitutional units comprising the residue of the hydroxyalkyl ester comprise 0.5% to 30% by weight, based on the total weight of the addition polymer.

49-69. (canceled)

70. The dispersion of claim 1, wherein the addition polymer has a Tg of 100° C. or less.

71-77. (canceled)

78. The dispersion of claim 1, wherein the dispersant is present in an amount of 0.5% to 40% by weight, based on the total solids weight of the dispersion.

79. (canceled)

80. The dispersion of claim 1, wherein the weight ratio of carbon nanotubes to dispersant is 250:1 to 1:1.

81-85. (canceled)

86. The dispersion of claim 1, wherein the dispersion further comprises an electrically conductive agent other than carbon nanotubes, and/or a fluoropolymer.

87-105. (canceled)

106. A slurry composition for producing a battery electrode comprising the dispersion of claim 1, an electrochemically active material, and a binder.

107. An electrode comprising an electrical current collector and a film formed on the electrical current collector, wherein the film is deposited from the slurry composition of claim 106.

108-112. (canceled)
